(19) United States
(12) Patent Application Publication
(10) Pub. No.: US 2008/0036812 A1
(43) Pub. Date: Feb. 14, 2008

(54) Image processing device and printing apparatus for performing bidirectional printing

(76) Inventor: Toshiaki Kakutani, Shiojiri-shi (JP)

Correspondence Address: MARTINE PENILLA & GENCARELLA, LLP, 710 LAKEWAY DRIVE, SUITE 200, SUNNYVALE, CA, 94085, US

(21) Appl. No.: 11/891,071

(22) Filed: Aug. 8, 2007

(30) Foreign Application Priority Data
Aug. 8, 2006 (JP) 2006-215950

(51) Int. Cl. B41J 2/025

(52) U.S. Cl. 347/15

(57) ABSTRACT

This invention provides a printing method of printing on a print medium with a print unit having a printing head. The method includes: generating dot data representing a status of dot formation on each print pixel of a print image to be formed on the print medium, by performing halftone process on image data representing a tone value of each pixel making up an original image to determine the status of dot formation; and printing a print image by forming dots on each print pixel of the print medium according to the dot data during both forward scan and backward scan of the printing head while performing main scan of the printing head. The printing includes: forming the print image by mutually combining dots formed on a first pixel group and dots formed on a second pixel group, the first pixel group being composed of a plurality of print pixels for which dots are formed during the forward scan of the printing head, the second pixel group being composed of a plurality of print pixels for which dots are formed during the backward scan of the printing head, in a common print area; and adjusting the print unit to reduce mutual misalignment of dot formation position in the main scanning direction between dots formed during the forward scan and dots formed during the backward scan for a specific dot making up specific binary image represented only by maximum and minimum values of the tone values. The generating includes setting a condition of the halftone process to reduce potential deterioration of picture quality due to a positional misalignment between the dots formed on the first pixel position group and the dots formed on the second pixel position group.

### BACKGROUND

1. Technical Field

This invention relates to technology for printing an image by forming dots on a print medium.

2. Related Art

In recent years, bidirectional inkjet printers that form images by forming ink dots bidirectionally in main scans are widely used as output devices for computers. For these bidirectional inkjet printers, attempts have been made to improve image quality by a variety of technologies including improving halftone technology such as an error diffusion method and others, suppressing mutual misalignment (improving precision) of recording position in the main scan direction between forward path and backward path, and the like as disclosed in JP-A-5-309839, JP-A-5-69625, JP-A-7-25101, JP-A-11-334055, JP-A-2000-296608, JP-A-2000-296609, and JP-A-2000-296648.

However, in conventional, since it was a technical common knowledge to consider improvement of image quality obtained by using halftone technology and improvement of image quality obtained by improving precision of dot formation position in separate ways from one another, no consideration has been made of synergistic improvement of image quality that can be attained by organically combining these technologies.

An advantage of some aspect of the invention is to provide a technique that improves image quality by organically combining halftone technology and technology for improving precision of dot formation position during bidirectional printing.

### SUMMARY

This invention provides a printing method of printing on a print medium with a print unit having a printing head. The method includes: generating dot data representing a status of dot formation on each print pixel of a print image to be formed on the print medium, by performing halftone process on image data representing a tone value of each pixel making up an original image to determine the status of dot formation; and printing a print image by forming dots on each print pixel of the print medium according to the dot data during both forward scan and backward scan of the printing head while performing main scan of the printing head. The printing includes: forming the print image by mutually combining dots formed on a first pixel group and dots formed on a second pixel group, the first pixel group being composed of a plurality of print pixels for which dots are formed during the forward scan of the printing head, the second pixel group being composed of a plurality of print pixels for which dots are formed during the backward scan of the printing head, in a common print area; and adjusting the print unit to reduce mutual misalignment of dot formation position in the main scanning direction between dots formed during the forward scan and dots formed during the backward scan for a specific dot making up specific binary image represented only by maximum and minimum values of the tone values. The generating includes setting a condition of the halftone process to reduce potential deterioration of picture quality due to a positional misalignment between the dots formed on the first pixel position group and the dots formed on the second pixel position group.

According to the printing method of this invention, conditions of the halftone processing are set such that degradation of granularity due to mutual misalignment of formation position between forward dots formed during the forward scan of the printing head and backward dots formed during the backward scan of the printing head is suppressed, and at the same time, for a specific dot making up specific binary image represented only by maximum and minimum values of the tone values, adjustment is made such that mutual misalignment of dot formation position in the main scanning direction between dots formed during the forward scan and dots formed during the backward scan is reduced. Accordingly, in case of intermediate tone image for which dot formation position is determined by the halftone processing, the halftone processing is executed such that degradation of granularity of the image targeted for dot formation is reduced by the halftone processing. On the other hand, in case of specific binary image (including color binary image) for which dot formation position is not determined by the halftone processing, such as text, line image, and the like, the printing unit is configured such that misalignment of dot formation position in the main scanning direction is reduced. It is therefore possible to improve image quality by organically combining the halftone technology (that attains lower granularity) and the technology for improving precision of dot formation position during bidirectional printing (that attains clear contours).

For a specific dot representing specific binary image represented only by maximum and minimum values of the tone values, pixels targeted for dot formation are not determined by the halftone processing due to the following reasons. That is, in case of printing vector data such as outline font regarding text and others, the halftone processing is not always required and thus may sometimes be skipped. Furthermore, even if the halftone processing is not skipped, the halftone processing may not be performed on specific binary image represented only by maximum and minimum values of the tone values, since pixels of the maximum tone value surely have dots formed thereon while pixels of the minimum tone value never have dots formed thereon.

The setting of conditions of the halftone processing as described above is not limited to cases where the halftone processing is performed using a dither matrix, but the present invention is also applicable to cases where the halftone processing is performed using an error diffusion method, for example. The use of error diffusion can be realized by having error diffusion processing performed for each of a plurality of pixel position groups, for example.

Specifically, another error diffusion processing may be performed for each of the plurality of pixel position groups in addition to the normal error diffusion, or alternatively, more weights may be assigned to errors diffused to the pixels belonging to the plurality of pixel position groups. This is because even with such configurations, inherent characteristics of error diffusion method allow each dot pattern formed on the print pixels belonging to each of the plurality of pixel groups to have specified characteristics for each of the tone values. Furthermore, these configurations may used in combination.

In the printing method noted above, the printing includes forming plural sizes of dots with different sizes, and the specific dot may be dots with the largest size among the plural sizes of dots.

Since binary image such as text, line image, and the like is formed by dots with the largest size, these dots are adjusted to reduce misalignment of dot formation position in the main scan direction. At the same time, dot formation position of dots having other sizes and representing intermediate tones is determined by the halftone processing that has a high level of robustness to misalignment of dot formation position. It is thus possible to attain high image quality without making neither binary image nor intermediate tone image targeted for trade-offs.

In the printing method noted above, the printing may include a step of forming black dots formed by black ink, cyan dots formed by cyan ink, magenta dots formed by magenta ink, and yellow dots formed by yellow ink, and in case where black-and-white printing is performed, the specific dot may be the black dots, or alternatively, the printing unit may be capable of forming black dots formed by black ink, cyan dots formed by cyan ink, magenta dots formed by magenta ink, and yellow dots formed by yellow ink, and in case where color printing is performed, the specific dot may be the black dots, the cyan dots, and the magenta dots.

In the printing method noted above, the printing may include a step of forming plural types of dots with different densities, and the specific dot may be dots with the highest density among the plural types of dots.

Since binary image such as text, line image, and the like is formed by dots with the highest density, these dots are adjusted to reduce misalignment of dot formation position in the main scan direction. At the same time, dot formation position of dots having other densities and representing intermediate tones is determined by the halftone processing that has a high level of robustness to misalignment of dot formation position. It is thus possible to attain high image quality without making neither binary image nor intermediate tone image targeted for trade-offs.

In the printing method noted above, both the dots formed on the first pixel group and the dots formed on the second pixel group may have either one of blue noise characteristics and green noise characteristics, respectively. Note that in this specification, the terms “blue noise characteristics” and “green noise characteristics” have meanings as defined in Robert Ulichney “Digital halftoning”.

In the printing method noted above, on the print medium, both the dots formed on the first pixel group and the dots formed on the second pixel group may have frequency characteristics that an average value of components within a specified low frequency range is smaller than an average value of components within another frequency range at least in the main scan direction, where the specified low frequency range is a spatial frequency domain within which visual sensitivity of human is at a highest level and ranges from 0.5 cycles per millimeter to 2 cycles per millimeter with a central frequency of 1 cycle per millimeter, and the another frequency range is a domain within which visual sensitivity of human is reduced to almost zero and ranges from 5 cycles per millimeter to 20 cycles per millimeter with a central frequency of 10 cycles per millimeter. In this way, it is possible to suppress granularity in the domain within which visual sensitivity of human is at a high level, thereby effectively improving image quality with a focus on visual sensitivity of human.

The technique of the invention is actualized by any of diverse applications including a printing device as well as computer programs for causing the computer to attain the functions of these methods and the apparatuses, recording media program product in which such computer programs are recorded.

### BRIEF DESCRIPTION OF THE DRAWING

FIG. 1 is an explanatory drawing showing the summary of a printing system as the printing apparatus of this embodiment;

FIG. 2 is an explanatory drawing showing the constitution of a computer as the image processing device of this embodiment;

FIG. 3 is an explanatory drawing showing the schematic structure of the color printer of this embodiment;

FIG. 4 is an explanatory drawing showing the internal schematic structure of the printing head 241;

FIG. 5 is a an explanatory drawing showing the principle of driving the nozzle Nz by a piezoelectric element PE;

FIG. 6 is a an explanatory drawing showing the correspondence relationship between a plurality of nozzle columns and a plurality of actuator chips that are provided at the printing head 241;

FIG. 7 is an exploded perspective view of the actuator circuit 90;

FIG. 8 is a partial cross sectional view of the actuator circuit 90;

FIG. 9 is an explanatory drawing showing position misalignment during bidirectional printing in relation with different nozzle columns;

FIG. 10 is an explanatory drawing showing the planar view of recording position misalignment;

FIG. 11 is an explanatory drawing showing the relationship between drive waveforms for the nozzles Nz and ink droplets Ip to be discharged therefrom, for the time ink is discharged;

FIG. 12 is an explanatory drawing describing the principle of forming dots of different sizes;

FIG. 13 is an explanatory drawing showing dot formation position misalignment of each dot type, i.e. large, medium, and small, during bidirectional printing;

FIG. 14 is an explanatory drawing showing target dot of position misalignment correction during bidirectional printing for each print mode;

FIGS. 15A and 15B are explanatory drawings showing the process in which an adjustment value for black-and-white printing is determined;

FIG. 16 is an explanatory drawings showing the process in which an adjustment value for black-and-white printing is determined;

FIGS. 17A and 17B are explanatory drawings showing the process in which an adjustment value for color printing is determined;

FIG. 18 is a flow chart showing the flow of the image printing process of this embodiment;

FIG. 19 is an explanatory drawing conceptually showing an LUT referenced for color conversion processing;

FIG. 20 is an explanatory drawing conceptually showing an example of part of a dither matrix;

FIG. 21 is an explanatory drawing conceptually showing the state of deciding the presence or absence of dot formation for each pixel while referencing the dither matrix;

FIG. 22 is an explanatory drawing showing the findings that became the beginning of the invention of this application;

FIG. 23 is an explanatory drawing conceptually showing an example the spatial frequency characteristics of threshold values set for each pixel of the dither matrix having blue noise characteristics;

FIGS. 24A, 24B, and 24C are explanatory drawings conceptually showing the sensitivity characteristics VTF for the spatial frequency of the visual sense that humans have;

FIGS. 25A, 25B, and 25C are explanatory drawings showing the results of studying the granularity index of forward scan images for various dither matrixes having blue noise characteristics;

FIGS. 26A and 26B are explanatory drawings showing the results of studying the correlation coefficient between the position misalignment image granularity index and the forward scan image granularity index;

FIG. 27 is an explanatory drawing showing the principle of it being possible to suppress the image quality degradation even when dot position misalignment occurs during bidirectional printing;

FIG. 28 is an explanatory drawing showing the degradation of image quality due to presence or absence of dot position misalignment with images formed using a general dither matrix;

FIG. 29 is a flow chart showing the flow of the process of generating a dither matrix referenced with the tone number conversion process of this embodiment;

FIGS. 30A and 30B are explanatory drawings showing the reason that it is possible to ensure image quality during the occurrence of dot position misalignment by not allowing mixing of first pixel positions and second pixel positions within the same raster;

FIG. 31 is an explanatory drawing showing the printing status by line printer 200L having printing heads 251 and 252 for the first variation example of the invention;

FIGS. 32A and 32B are explanatory drawings showing the printing status using the interlace recording method for the second variation example of the invention;

FIG. 33 is an explanatory drawing showing the printing status using the overlap recording method for the third variation example of the invention;

FIG. 34 is an explanatory drawing showing a group of eight pixel positions classified according to the number of remainders when the path number is divided by 8;

FIGS. 35A, 35B, and 35C are explanatory drawings showing an example of the actual printing status for the bidirectional printing method of the fourth variation example of the invention; and

FIG. 36 is an explanatory drawing showing the state of the printing image being formed with mutually combining four pixel position groups in a common printing area in a case when conventional halftone processing was performed.

### DESCRIPTION OF THE PREFERRED EMBODIMENT

The present invention is explained in the following sequence based on embodiments.

### A. Summary of the Embodiment:

B-1. Hardware configuration of print Device:

B-2. Dot Formation Position Misalignment during Bidirectional Printing due to Hardware Construction:

### C. Summary of the Image Printing Process:

D. Principle of Suppressing Degradation of Image Quality Due to Dot Position misalignment:

### E. Dither Matrix Generating Method:

### F. Variation Examples:

### A. SUMMARY OF THE EMBODIMENTS

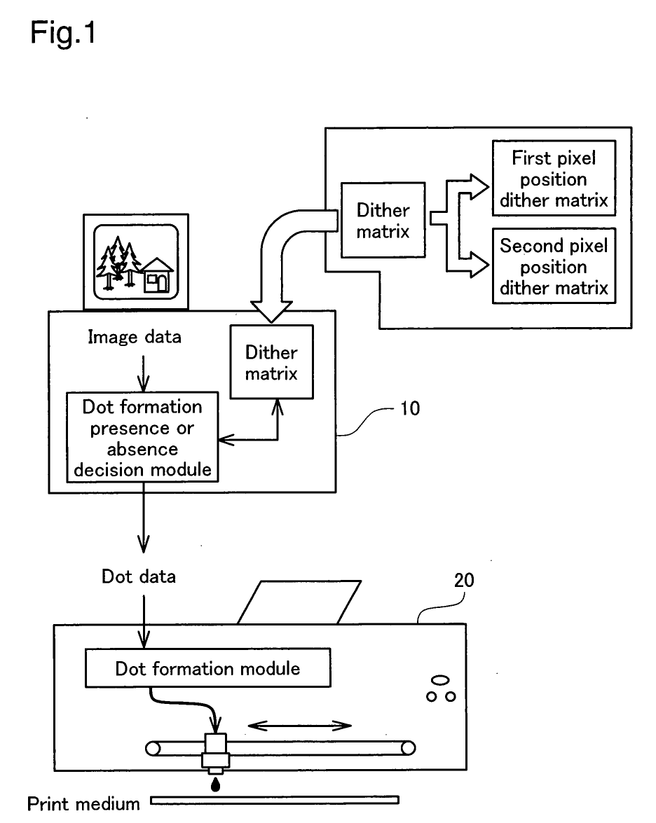

Before starting the detailed description of the embodiment, a summary of the embodiment is described while referring to FIG. 1. FIG. 1 is an explanatory drawing showing a summary of a printing system as the printing apparatus of this embodiment. As shown in the drawing, the printing system consists of a computer 10 as the image processing device, a printer 20 that prints the actual images under the control of the computer 10 and the like, and entire system is unified as one and functions as a printing apparatus.

A dot formation presence or absence decision module and a dither matrix are provided in the computer 10, and when the dot formation presence or absence decision module receives image data of the image to be printed, while referencing the dither matrix, data (dot data) is generated that represents the presence or absence of dot formation for each pixel, and the obtained dot data is output toward the printer 20.

A dot formation head 21 that forms dots while moving back and forth over the print medium and a dot formation module that controls the dot formation at the dot formation head 21 are provided in the printer 20. When the dot formation module receives dot data output from the computer 10, dot data is supplied to the head to match the movement of the dot formation head 21 moving back and forth. As a result, the dot formation head 21 that moves back and forth over the print medium is driven at a suitable timing, forms dots at suitable positions on the print medium, and an image is printed.

Also, with the printing apparatus of this embodiment, by performing so called bidirectional printing for which dots are formed not only during forward scan of the dot formation head 21 but also during backward scan, it is possible to rapidly print images. It makes sense that when performing bidirectional printing, when dot formation position misalignment occurs between dots formed during forward scan and dots formed during backward scan, the image quality is degraded. In light of this, it is normal to have built into this kind of printer a special mechanism or control for adjusting at a high precision the timing of dot formation of one of the back and forth movements to the other timing, and this is one factor in causing printers to be larger or more complex.

Considering this kind of point, with the printing apparatus of this embodiment shown in FIG. 1, as the dither matrix referenced when generating dot data from the image data, a matrix having at least the following two characteristics is used. Specifically, as the first characteristic, this is a matrix for which it is possible to classify the dither matrix pixel positions into a first pixel position group and a second pixel position group. Here, the first pixel position and the second pixel position are pixel positions having a relationship whereby when one has dots formed at either the forward scan or the backward scan, the other has dots formed at the opposite. Then as the second characteristic, this is a matrix for which the dither matrix, a matrix for which the threshold values set for the first pixel positions are removed from the dither matrix (first pixel position matrix), and a matrix for which the threshold values set for the second pixel positions are removed (second pixel position matrix) all have blue noise characteristics.

Here, though the details are described later, the inventors of this application discovered the following kind of new findings. Specifically, there is a very strong correlation between the image quality of images for which the dot formation position was displaced between the forward scan and the backward scan and the image quality of images made only by dots formed during forward scan (images obtained with only the dots formed during the backward scan removed from the original image; hereafter called “forward scan images”), or the image quality of images made only by dots formed during backward scan (images obtained with only the dots formed during the forward scan removed from the original image; hereafter called “backward scan images”). Then, if the image quality of the forward scan images or the image quality of the backward scan images is improved, even when dot formation position misalignment occurs between the forward scan and the backward scan of bidirectional printing, it is possible to suppress degradation of image quality. Therefore, the dither matrix can be classified by the characteristics noted above, specifically, it is possible to classify as a first pixel position matrix and a second pixel position matrix, and if dot data is generated using a dither matrix such as one for which these three matrixes have blue noise characteristics, it is possible to have both the forward scan images and the backward images be good image quality images, so it is possible to suppress to a minimum the degradation of image quality even when there is dot formation position misalignment during bidirectional printing. As a result, when adjusting the dot formation timing of one of the back and forth movements to the other timing, there is no demand for high precision, so it is possible to have a simple mechanism and control for adjustment, and thus, it is possible to avoid the printer becoming large and complex. Following, this kind of embodiment is described in detail.

B-1. Hardware Configuration of Print Device:

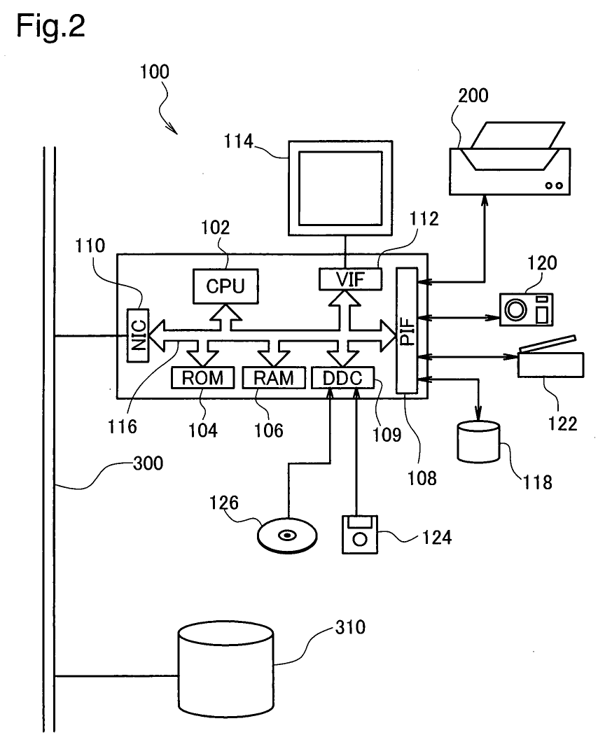

FIG. 2 is an explanatory drawing showing the constitution of the computer 100 as the image processing device of this embodiment. The computer 100 is a known computer constituted by a CPU 102 as the core, a ROM 104, a RAM 106 and the like being mutually connected by a bus 116.

Connected to the computer 100 are a disk controller DDC 109 for reading data of a flexible disk 124, a compact disk 126 or the like, a peripheral device interface PIF 108 for performing transmission of data with peripheral devices, a video interface VIF 112 for driving a CRT 113, and the like. Connected to the PIF 108 are a color printer 200 described later, a hard disk 118, or the like. Also, if a digital camera 120 or color scanner 122 or the like is connected to the PIF 108, it is possible to perform image processing on images taken by the digital camera 120 or the color scanner 122. Also, if a network interface card NIC 110 is mounted, the computer 100 is connected to the communication line 300, and it is possible to fetch data stored in the storage device 310 connected to the communication line. When the computer 100 fetches image data of the image to be printed, by performing the specified image processing described later, the image data is converted to data representing the presence or absence of dot formation for each pixel (dot data), and output to the color printer 200.

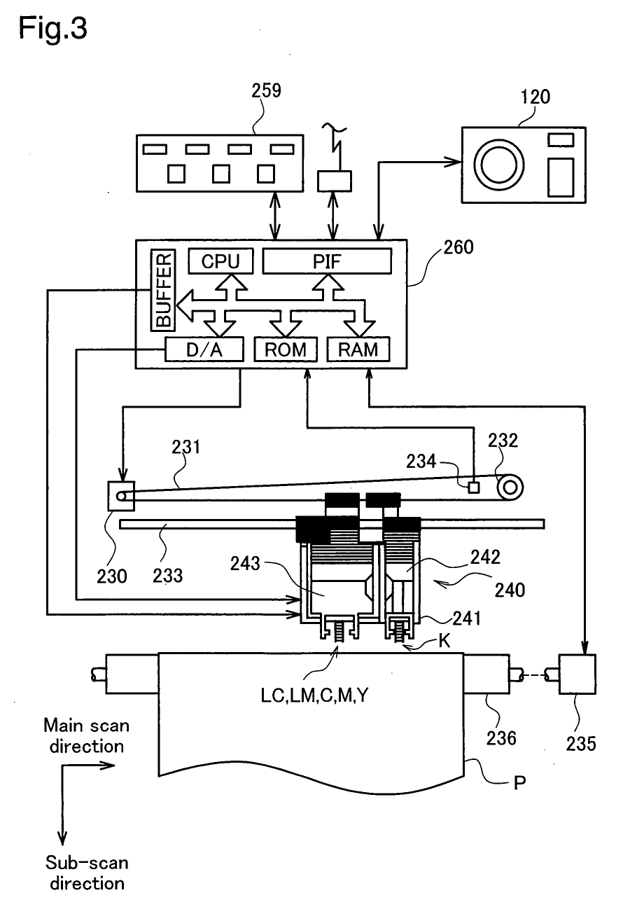

FIG. 3 is an explanatory drawing showing the schematic structure of the color printer 200 of this embodiment. The color printer 200 is an ink jet printer capable of forming dots of four colors of ink including cyan, magenta, yellow, and black. Of course, in addition to these four colors of ink, it is also possible to use an inkjet printer capable of forming ink dots of a total of six colors including an ink with a low dye or pigment concentration of cyan (light cyan) and an ink with a low dye or pigment concentration of magenta (light magenta). Note that following, in some cases, cyan ink, magenta ink, yellow ink, black ink, light cyan ink, and light magenta ink are respectively called C ink, M ink, Y ink, K ink, LC ink, and LM ink.

As shown in the drawing, the color printer 200 consists of a mechanism that drives a printing head 241 built into a carriage 240 and performs blowing of ink and dot formation, a mechanism that moves this carriage 240 back and forth in the axial direction of a platen 236 by a carriage motor 230, a mechanism that transports printing paper P by a paper feed motor 235, a control circuit 260 that controls the dot formation, the movement of the carriage 240 and the transport of the printing paper, and the like.

Mounted on the carriage 240 are an ink cartridge 242 that stores K ink, and an ink cartridge 243 that stores each type of ink, i.e. C ink, M ink, and Y ink. When the ink cartridges 242 and 243 are mounted on the carriage 240, each ink within the cartridge passes through an introduction tube that is not illustrated and is supplied to each color ink spray head i.e. K, C, LC, M, LM, and Y (which will be described later) provided on the bottom surface of the printing head 241.

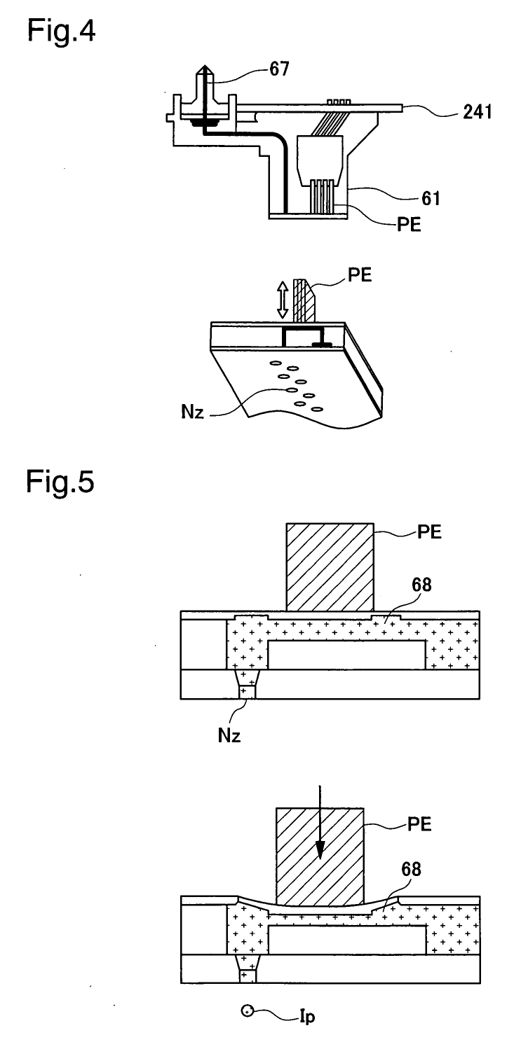

FIG. 4 is an explanatory drawing showing the internal schematic structure of the printing head 241. When the ink cartridges 242 and 243 are mounted on the carriage 240, each ink within the ink cartridge is sucked out via an introduction tube 67 and is introduced to nozzles Nz of the printing head 241 provided at the bottom of the carriage 240.

FIG. 5 is an explanatory drawing showing the principle of driving the nozzle Nz by a piezoelectric element PE. The piezoelectric element PE is provided at a position adjacent to an ink conduit 68 that introduces the ink to the nozzle Nz. In the present embodiment, applying a voltage of predetermined duration to electrodes provided on both ends of the piezoelectric element PE causes the piezoelectric element PE to expand rapidly and thereby deforms one side wall of the ink conduit 68. As a result, the volume of the ink conduit 68 is contracted according to the expansion of the piezoelectric element PE and an amount of ink corresponding to the contraction is discharged from the end of the nozzle Nz as a droplet Ip. The ink droplet Ip is then soaked into the paper P attached to a platen 236, thereby causing printing.

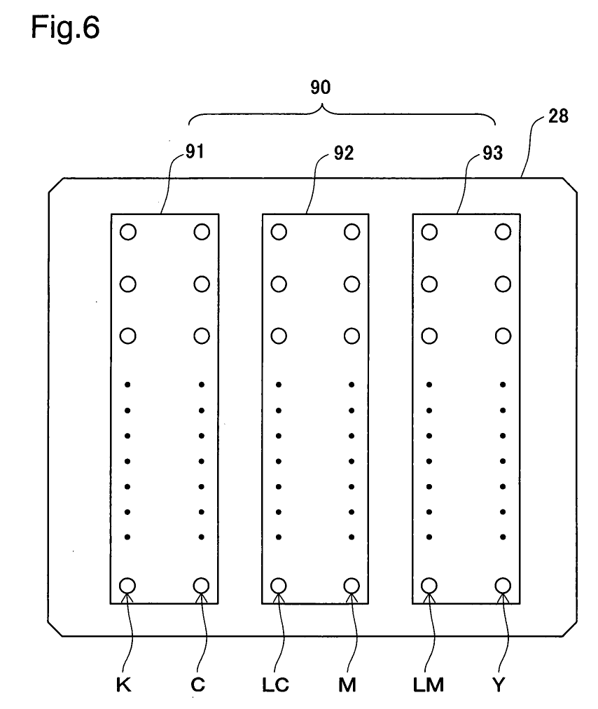

FIG. 6 is an explanatory drawing showing the correspondence relationship between a plurality of nozzle columns and a plurality of actuator chips that are provided at the printing head 241. The printer 20 is a printing apparatus that performs printing by using six colors of inks, i.e. black (K), cyan (C), light cyan (LC), magenta (M), light magenta (LM), and yellow (Y), and has nozzle columns for respective ink colors. The cyan and the light cyan are cyan inks of substantially the same hue but of different densities. The same applies to the magenta ink and the light magenta ink.

An actuator circuit 90 is provided with: a first actuator chip 91 that drives a black nozzle column K and a cyan nozzle column C; a second actuator chip 92 that drives a light cyan nozzle column LC and a magenta nozzle column M; and a third actuator chip 93 that drives a light magenta nozzle column LM and a yellow nozzle column Y.

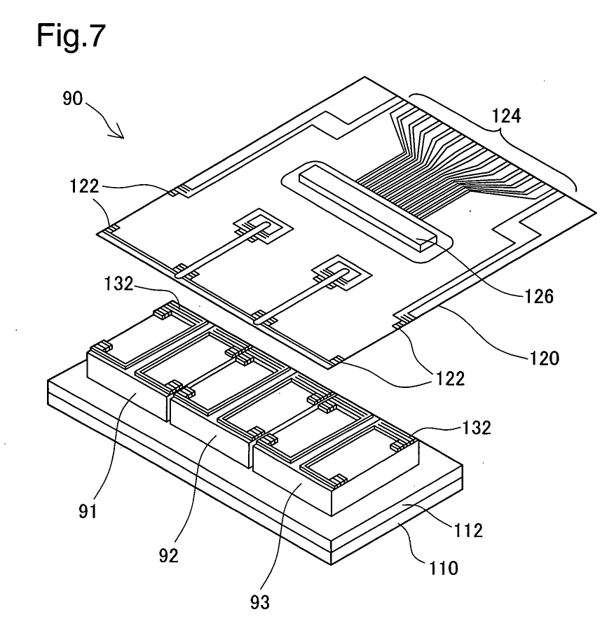

FIG. 7 is an exploded perspective view of the actuator circuit 90. The three actuator chips 91 through 93 are bonded on a laminate of a nozzle plate 110 and a reservoir plate 112 by using an adhesive. In addition, a connecting terminal plate 120 is fixed on the actuator chips 91 through 93. External connecting terminals 124 for electrically connecting with an external circuit (I/F specific circuit 50, specifically) are formed at one end of the connecting terminal plate 120. In addition, internal connecting terminals 122 for electrically connecting with the actuator chips 91 through 93 are provided underside of the connecting terminal plate 120. Furthermore, a driver IC 126 is provided on the connecting terminal plate 120. Within the driver IC 126, a circuit that latches a print signal provided from the computer 10, an analog switch for switching on or off a drive signal in response to the print signal, and the like are provided. Note that wirings between the driver IC 126 and the connecting terminals 122, 124 are not illustrated.

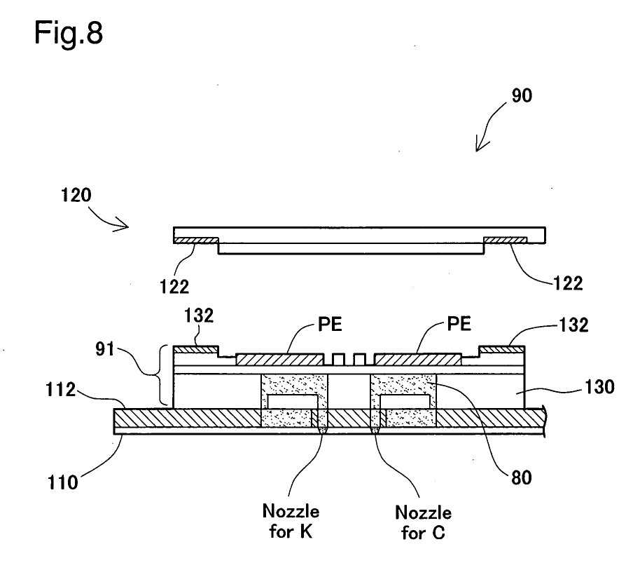

FIG. 8 is a partial cross sectional view of the actuator circuit 90. Although only the first actuator 91 and the connecting terminal plate 120 thereon are illustrated, other actuator chips 92, 93 also have the same structure as the first actuator chip 91, respectively.

Nozzle openings for respective inks are formed in the nozzle plate 110. The reservoir plate 112 is a plate-like body for forming ink reservoirs. The actuator chip 91 has: a ceramic sintered body 130 that forms ink conduits 68 (FIG. 5); piezoelectric elements PE disposed thereabove via a wall surface; and terminal electrodes 132. When the connecting terminal plate 120 is fixed on the actuator chip 91, the connecting terminals 122 provided underside of the connecting terminal plate 120 are electrically connected with the terminal electrodes 132 provided on the top surface of the actuator chip 91. Note that wirings between the terminal electrode 132 and the piezoelectric elements PE are not illustrated.

B-2. Dot Formation Position Misalignment During Bidirectional Printing Due to Hardware Construction:

In a printing apparatus that is epitomized by the hardware construction described above, dot formation position misalignment occurs during bidirectional printing. Such dot formation position misalignment occurs firstly between nozzle columns, and secondly between dots with different sizes from each other, as will be described below.

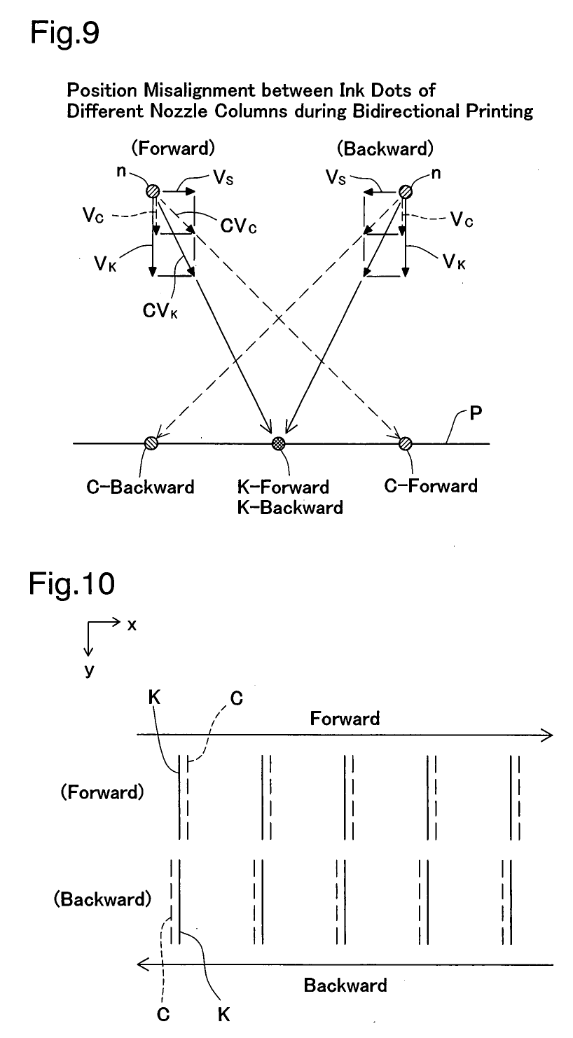

FIG. 9 is an explanatory drawing showing position misalignment during bidirectional printing in relation with different nozzle columns (ink colors). A nozzle Nz moves bidirectionally and horizontally above a printing paper P, discharges ink in each of forward path and backward path, and thereby forms dots on the printing paper P. In the illustration, the case of discharging black ink K and the case of discharging cyan ink C are shown in a superimposed manner. Now we will assume the black ink K is discharged at a discharge speed of V_{K} in a vertical and downward direction, while the cyan ink C is discharged at a discharge speed of V_{C} which is lower than the discharge speed of the black ink. A synthesized speed vector CV_{K} or CV_{C} of each color is obtained by synthesizing the corresponding discharge speed vector in the downward direction and a main scan speed vector V_{S} of the nozzle Nz. Since the black ink K and the cyan ink C have different discharge speeds V_{K}, V_{C} in the downward direction, the resultant synthesized speeds CV_{K}, CV_{C} have different sizes and directions from each other, too.

In this example, correction is made such that the position misalignment between black dots becomes zero, for ease of explanation. However, since the synthesized speed vector CV_{C} of the cyan ink C differs from the synthesized speed vector CV_{K} of the black ink K, discharging the cyan ink C at the same timing as the black ink K causes a large amount of misalignment occurring between recording positions of cyan dots on the printing paper P. In addition, as can be seen, the relative positional relationship (left-to-right relationship) between a black dot and a cyan dot in the forward path is a reverse of the relative positional relationship between a black dot and a cyan dot in the backward path. Since such differences are reflected in the optimal value of position misalignment correction, black-and-white printing and color printing will have different optimal values of position misalignment correction from each other. That is to say, in black-and-white printing, optimization is performed only for the black ink; whereas in color printing, optimization is performed for the inks of LC, LM, C, M, Y, and K and the correction value thus optimized is used as the optimal value of position misalignment correction.

FIG. 10 is an explanatory drawing showing the planar view of recording position misalignment shown in FIG. 9. Here shows the case where the black ink K and the cyan ink C are used to record vertical ruled lines along the sub-scan direction in each of the forward path and the backward path. The vertical ruled lines of the black ink that are recorded in the forward path have the same positions in the main scan direction as the vertical ruled lines of the black ink recorded in the backward path, respectively. On the other hand, the vertical ruled lines of the cyan ink that are recorded in the forward path are recorded to the right side of the vertical ruled lines of the black ink, respectively, and the vertical ruled lines of the cyan ink that are recorded in the backward path are recorded to the left side of the vertical ruled lines of the black ink, respectively.

As just described, if the correction of recording position misalignment between the forward path and the backward path is carried out only in relation to the black nozzle column, then recording position misalignment will occur in relation to other nozzle columns.

The discharge speed of ink droplet discharged from each nozzle column varies depending on various factors as follows:

(1) manufacturing error of actuator chip;
(2) physical property of ink (e.g. viscosity); and
(3) weight of ink droplet.

In case where manufacturing error of each actuator chip is the key factor influencing the discharge speed of ink droplet, then all ink droplets discharged from the same actuator chip will have substantially the same discharge speed. Therefore, in this case, it has been necessary to correct recording position misalignment in the main scan direction for each group of nozzle columns driven by each actuator chip. On the other hand, in case where physical property of ink, weight of ink droplet, or the like also has a great influence on the discharge speed of ink droplet, then it has been necessary to correct dot recording position misalignment in the main scan direction for each type of ink or for each nozzle column.

Secondly, dot formation position misalignment occurs between dots of different sizes from each other due to the following factors. Although the printer 200 of the present embodiment includes nozzles Nz of uniform diameter as shown in FIG. 6, such nozzles Nz can be used to form three types of dots of different diameters.

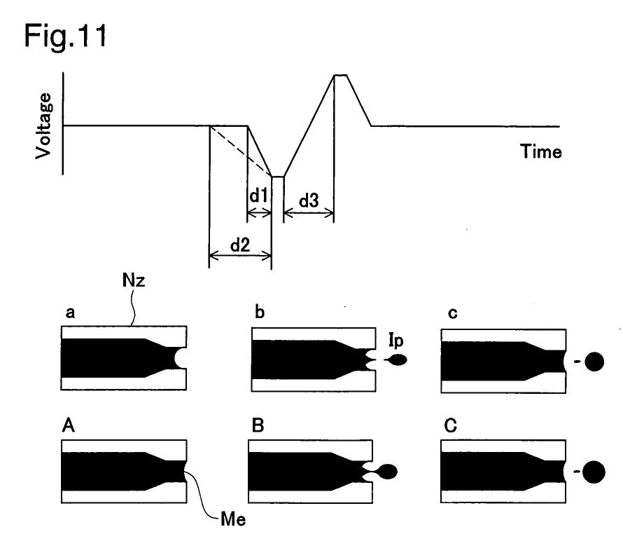

FIG. 11 is an explanatory drawing showing the relationship between drive waveforms for the nozzles Nz and ink droplets Ip to be discharged therefrom, for the time ink is discharged. A drive waveform shown by a dashed line in FIG. 11 is a waveform that is used when a normal type of dot is to be discharged. Once a negative voltage is applied to the piezoelectric element PE in section d2, the piezoelectric element PE deforms in a direction that increases the cross section of the ink conduit 68, i.e. in the opposite direction from the case described previously with reference to FIG. 5. Because the speed of ink supply from the introduction tube 67 (FIG. 4) is limited, the amount of ink supply runs short in response to the expansion of the ink conduit 68. As a result, an ink boundary face Me, which is referred to as meniscus, becomes smashed inwardly into the nozzle Nz as shown by a state of “A” in FIG. 11. On the other hand, when a drive waveform shown by a solid line in FIG. 11 is used to apply a negative voltage in a rapid manner as shown by section d1, the amount of ink supply runs short to a greater extent. Accordingly, the meniscus becomes smashed inwardly into the nozzle Nz to a greater extent than the state of “A”, as shown by a state of “a”. Subsequently, when the voltage applied to the piezoelectric element PE is changed to a positive voltage (section d3), the ink is discharged based on the principle described previously with reference to FIG. 5. At this time, a large ink droplet as shown by states “B”, “C” is discharged from the state (“A”) in which the meniscus is not so much smashed inwardly, and a small ink droplet as shown by states “b”, “c” is discharged from the state (“a”) in which the meniscus is greatly smashed inwardly.

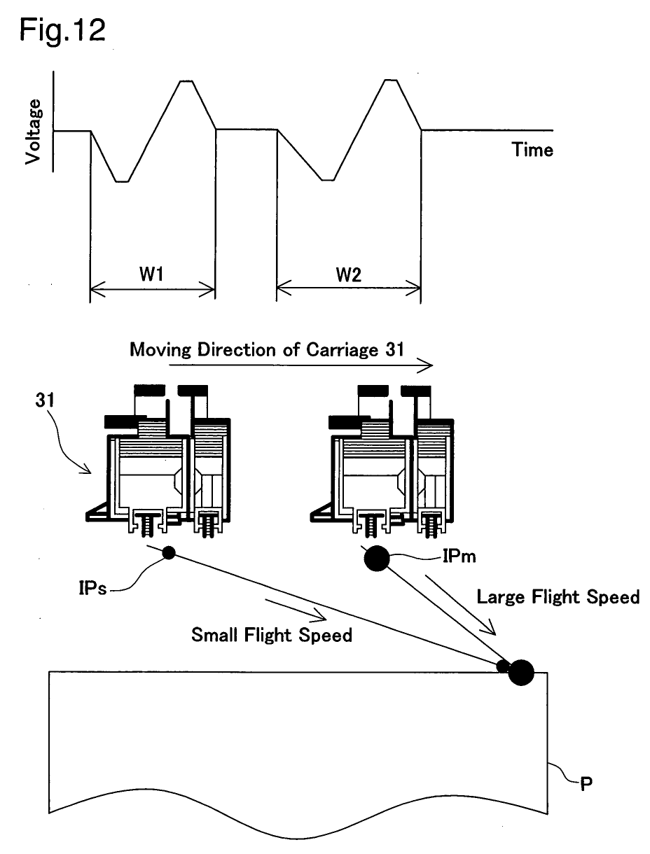

As described above, the dot diameter can be varied according to the rate of change by which the drive voltage is changed to a negative voltage (sections d1, d2). In the present embodiment, two types of drive waveforms are prepared based on such relationship between drive waveform and dot diameter. One is a drive waveform used to form a small dot IP1 of small dot diameter, and the other is a drive waveform used to form a medium dot IP2 of second-smallest diameter. The drive waveforms used in the present embodiment are shown in FIG. 12. The drive waveform W1 is a waveform used to form the small dot IP1, and the drive waveform W2 is a waveform used to form the medium dot IP2. By using either one of these drive waveforms according to needs, two types of dots, i.e. the dot of small diameter and the dot of medium diameter, can be formed by the nozzles Nz of uniform nozzle diameter. In the printer 200 of the present embodiment, these drive waveforms are output continuously and periodically in the order of W1, W2 as the carriage 240 is moved.

In addition, a large dot can be formed by using both of the drive waveforms W1, W2 of FIG. 12. The process is shown in the lower half of FIG. 12. The lower half of FIG. 12 shows the process from the discharging of a small dot ink droplet IPs and a medium dot ink droplet IPm by the nozzle to the arriving of the droplets on the printing paper P. In case where the two types of dots i.e. the small dot and the medium dot are to be formed, a larger amount of ink is supplied in the ink conduit 68 when the medium dot is to be formed than when the small dot is to be formed, as is clear from the states of meniscuses shown in FIG. 11. Accordingly, the medium dot ink droplet Ipm is discharged more swiftly than the small dot ink droplet IPs. Since there is such difference between the flight speeds of inks, in case where the small dot and the medium dot are to be discharged continuously as the carriage 240 is moved in the main scan direction, the scan speed of the carriage and the discharge timings for the dots can be adjusted according to the distance between the carriage 240 and the paper P in such a way that allows both of the ink droplets to arrive at the paper P at substantially the same timing. In the present embodiment, the large dot of largest dot diameter is formed in this way, by using the two types of drive waveforms shown in the upper half of FIG. 12.

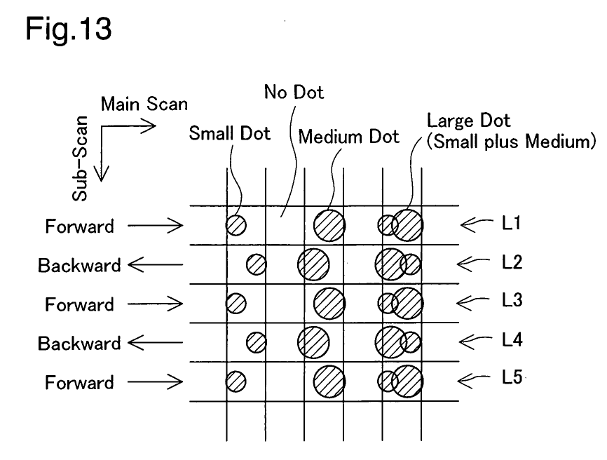

FIG. 13 is an explanatory drawing showing dot formation position misalignment of each dot type, i.e. large, medium, and small, during bidirectional printing. FIG. 13 shows an example in which adjustment of dot formation position is carried out for the large dot as a target dot (type of dot targeted for adjustment), for ease of explanation. As will be appreciated from the drawing, in bidirectional printing, the position at which an ink droplet arrives differs between forward path and backward path in the main scan direction. That is to say, an ink droplet of relatively small amount that is used to record the small dot arrives at the left half of the pixel region in the forward path and at the right half of the pixel region in the backward path. To the contrary, an ink droplet of relatively large amount that is used to record the medium dot arrives at the right half of the pixel region in the forward path and at the left half of the pixel region in the backward path.

As just described, it turns out that in the printing apparatus, dot formation position misalignment occurs for each dot type such as dot size, nozzle column, and the like due to constructional reasons of hardware. Accordingly, conventionally, it has been desirable to carry out adjustment of dot formation position for each dot type. However, in order to carry out adjustment for each dot type, it is necessary to make fine adjustment based on too many parameters such as adjustment of discharge timing for each nozzle column, adjustment of timing for each of the drive waveforms W1, W2, and the like, and thus is not practical. For this reason, technologies have been proposed to carry out adjustment only for the large dot, which greatly affects degradation of image quality, as the target dot (type of dot targeted for adjustment), to change the target dot for each print mode, and the like.

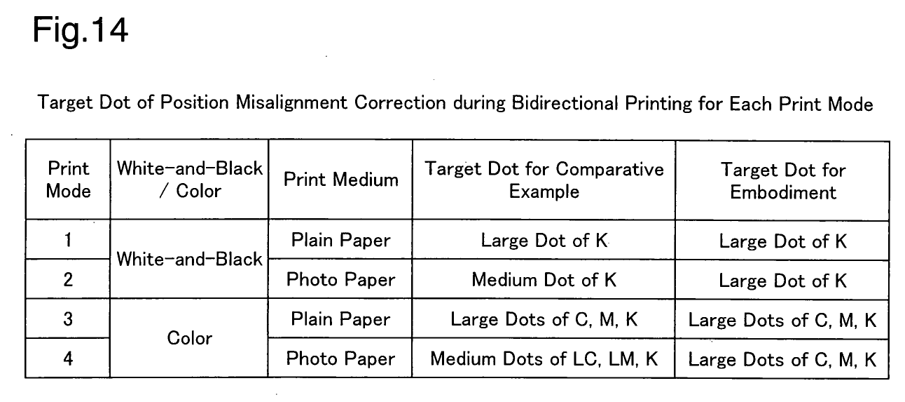

FIG. 14 is an explanatory drawing showing the target dot of position misalignment correction during bidirectional printing for each print mode. In this table, the target dot is indicated for a comparative example as the conventional method and for the embodiment of the present invention. In this drawing, print parameters are indicated such as black-and-white printing or color printing, the type of print medium, and the like as parameters for representing each print mode. For example, in the comparative example, only the black ink is selected as the target dot in black-and-white printing. On the other hand, in color printing, the black ink and other specific color inks are selected as target dots. Furthermore, as for the type of print medium, the large dot is targeted for adjustment in case of plain paper, while the medium dot is targeted for adjustment in case of photo paper. Note that the “target dot” corresponds to “specific dot” as defined in the scope of claim for patent.

The selection of target dot in relation to the type of print medium is based on the following reasons. That is to say, if the print medium is plain paper, then generally a document that mainly contains text is to be printed, so that the large dot for forming text, ruled line, and the like is selected as the target dot in order to print the outline of text, ruled line, and the like in a beautiful way. On the other hand, if the print medium is photo paper, then generally a picture is to be printed, so that among the medium dot and the small dot for forming picture, the medium dot that is more likely to cause degradation of image quality is selected as the target dot. Furthermore, the light cyan ink and the light magenta ink are also selected as target inks on the ground that the light cyan ink and the light magenta ink are more likely to cause degradation of image quality due to dot formation position misalignment than the cyan ink and the magenta ink. Note that the yellow ink is not targeted because of its inconspicuousness.

However, in case where both picture and text exist at the same main scan position, the picture and the text could not be printed in a beautiful way by the technology described above. In order to address such problem, the present embodiment organically combines the halftone technology that, as will be described below, has a high level of robustness to dot formation position misalignment caused by main scan and the technology for adjusting dot formation position, thereby attaining high image quality without making neither binary image such as text, line image, and the like nor intermediate tone image such as picture and the others targeted for trade-offs.

Referring to the target dot of the embodiment indicated in FIG. 14, only the large dot of black ink is targeted for adjustment either for plain paper or photo paper in black-and-white printing. This is because in photo printing, dot formation position is determined by the halftone processing that has a high level of robustness to dot formation position misalignment, so that dot formation position misalignment of the small dot for forming photo print image does not present any problem. On the other hand, although such halftone processing is not actually performed on binary image such as text, line image, and the like, highest level of image quality can be achieved since dot formation position has been optimized in relation to the large dot for forming text, line image, and the like. The reason the halftone processing is not actually performed for binary image such as text, line image, and the like (including color image which will be described later) is that in such image, pixels of the maximum tone value surely have dots formed thereon while pixels of the minimum tone value never have dots formed thereon, and thus results in substantially no halftone processing performed.

On the other hand, in color printing, only the large dots of cyan ink, magenta ink, and black ink are targeted for adjustment either for plain paper or photo paper. This is because for photo printing, dot formation position is determined by the halftone processing that has a high level of robustness to dot formation position misalignment, as in the case of black-and-white printing described above. On the other hand, for color binary image such as text, line image, and the like, dot formation position is optimized in relation to the large dots of cyan ink, magenta ink, and black ink for forming text, line image, and the like, so that highest level of image quality can be achieved.

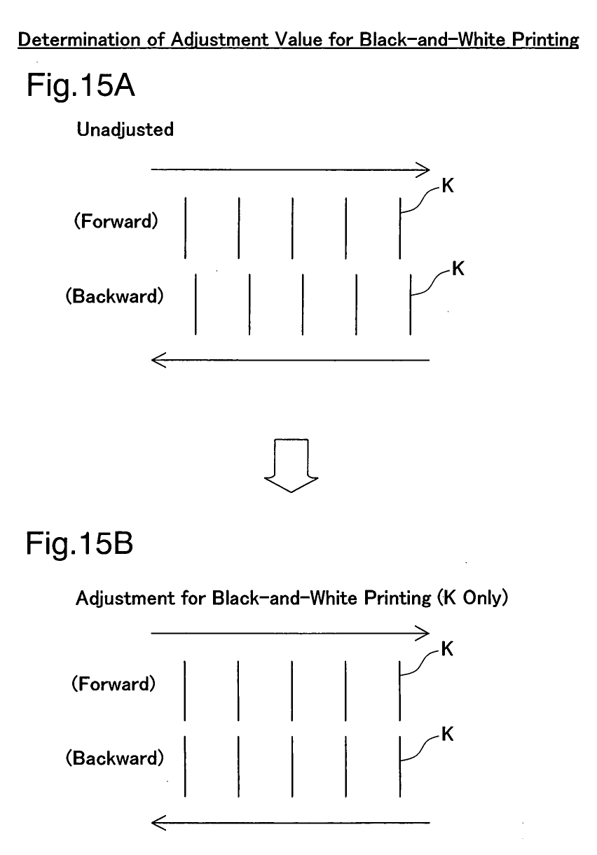

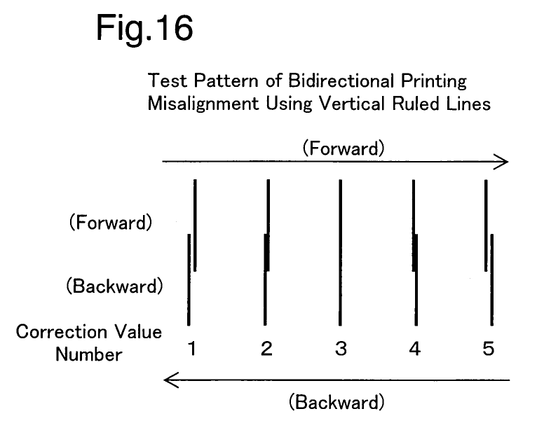

FIGS. 15A and 15B and FIG. 16 are explanatory drawings each showing the process in which an adjustment value for black-and-white printing is determined. In the upper half of FIGS. 15A and 15B, a plurality of ruled lines are formed by using the large dot of black ink before adjustment. In the lower half of FIGS. 15A and 15B, a plurality of ruled lines are formed by using the large dot of black ink after adjustment. FIG. 16 shows one example for attaining such adjustment. A plurality of ruled lines shown in FIG. 16 are obtained as a result of inputting different values for correcting drive signal timings (timing correction values), respectively. The number that results in minimum misalignment is selected from among these ruled lines to determine a timing correction value, and then the determined timing correction value is stored in nonvolatile memory (not illustrated) of the printing apparatus (FIG. 3).

The timing correction value thus stored is used by the control circuit 260, which controls formation of dots, movement of the carriage 240, and transfer of print papers, so as to determine drive signal timings. In this manner, the control circuit 260 functions as an “adjustment unit for reducing mutual misalignment of dot formation position in the main scan direction” as defined in scope of claim for patent.

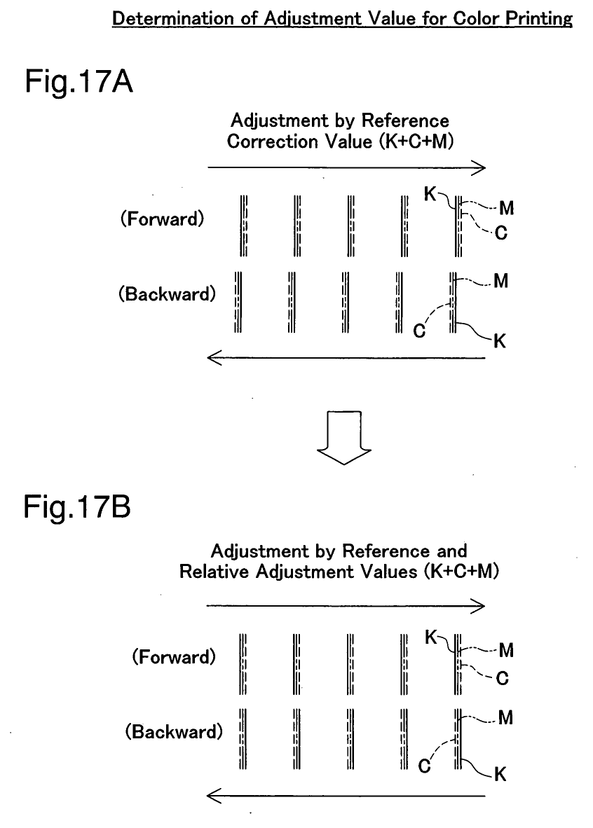

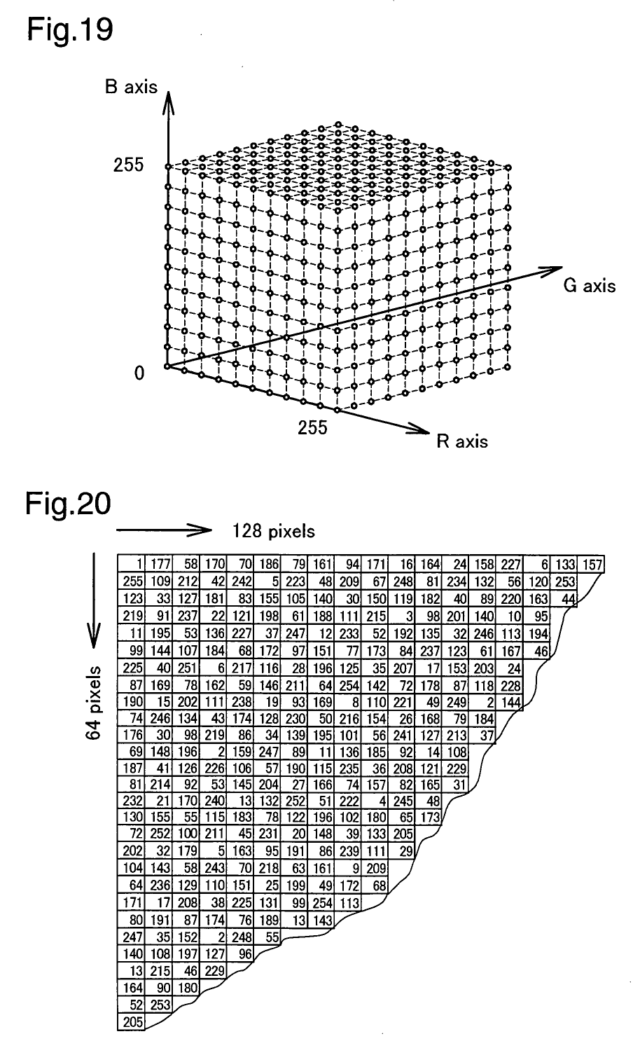

FIGS. 17A and 17B are explanatory drawings showing the process in which an adjustment value for color printing is determined. A plurality of ruled lines shown in FIG. 19 are formed by the large dots of cyan ink, magenta ink, and black ink. Again, the number that results in minimum misalignment is selected from among these ruled lines to determine a timing correction value, and then the determined timing correction value is stored in nonvolatile memory (not illustrated) of the printing apparatus.

As described above, in the embodiment of the present invention, it is configured such that for a specific dot making up binary image such as text, line image, and the like, dot formation position misalignment in the main scan direction is reduced between dots formed during forward scan and dots formed during backward scan, and at the same time, conditions of halftone processing are set such that degradation of granularity due to dot formation position misalignment between forward scan dots formed during forward scan of the printing head and backward scan dots formed during backward scan of the printing head is suppressed. It is therefore possible to improve image quality by organically combining the halftone technology and the technology for improving precision of dot formation position during bidirectional printing. The halftone technology upon which the technology of the present embodiment is based can be attained in the following manner.

The inventors of the present application also performed experimental quantitative analysis on granularity. As a result of their analysis, it was discovered that conditions of the halftone processing are preferably set such that on print medium, both a dot group formed during forward scan and a dot group formed during backward scan have frequency characteristics that, an average value of components within a specified low frequency range is smaller than an average value of components within another frequency range at least in the main scan direction, where the specified low frequency range is a spatial frequency domain within which visual sensitivity of human is at a highest level and ranges from 0.5 cycles per millimeter to 2 cycles per millimeter with a central frequency of 1 cycle per millimeter, and another frequency range is a domain within which visual sensitivity of human is reduced to almost zero and ranges from 5 cycles per millimeter to 20 cycles per millimeter with a central frequency of 10 cycles per millimeter. According to the conditions, it is possible to suppress granularity in the domain within which visual sensitivity of human is at a high level, thereby effectively improving image quality with a focus on visual sensitivity of human.

C. Summary of the Image Printing Process

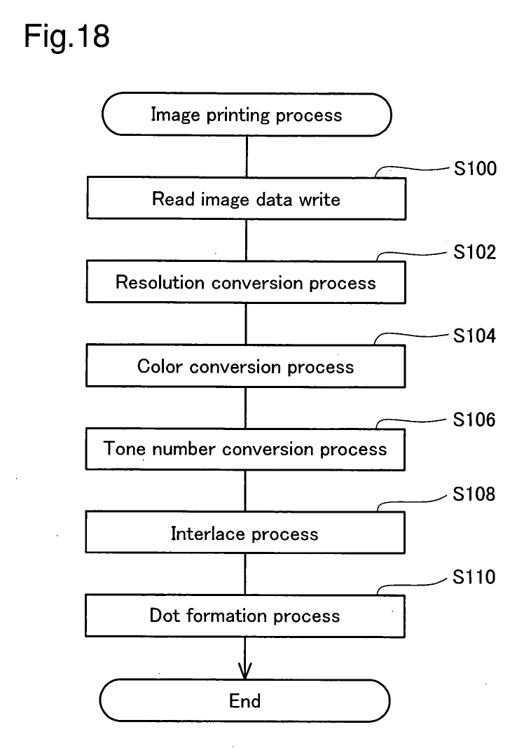

FIG. 18 is a flow chart showing the process flow of adding a specified image process by the computer 100 to an image to be printed, converting image data to dot data expressed by the presence or absence of dot formation, supplying to the color printer 200 as control data the obtained dot data, and printing the image.

When the computer 100 starts image processing, first, it starts reading the image data to be converted (step S100) Here, the image data is described as RGB color image data, but it is not limited to color image data, and it is also possible to apply this in the same way for black and white image data as well.

After reading of the image data, the resolution conversion process is started (step S102). The resolution conversion process is a process that converts the resolution of the read image data to resolution (printing resolution) at which the color printer 200 is to print the image. When the print resolution is higher than the image data resolution, an interpolation operation is performed and new image data is generated to increase the resolution. Conversely, when the image data resolution is higher than the printing resolution, the resolution is decreased by culling the read image data at a fixed rate. With the resolution conversion process, by performing this kind of operation on the read image data, the image data resolution is converted to the printing resolution.

Once the image data resolution is converted to the printing resolution in this way, next, color conversion processing is performed (step S104). Color conversion processing is a process of converting RGB color image data expressed by a combination of R, G, and B tone values to image data expressed by combinations of tone values of each color used for printing. As described previously, the color printer 200 prints images using four colors of ink C, M, Y, and K. In light of this, with the color conversion process of this embodiment, the image data expressed by each color RGB undergoes the process of conversion to data expressed by the tone values of each color C, M, Y, and K.

The color conversion process is able to be performed rapidly by referencing a color conversion table (LUT). FIG. 19 is an explanatory drawing that conceptually shows the LUT referenced for color conversion processing. The LUT can be thought of as a three dimensional number chart if thought of in the following way. First, as shown in FIG. 19, we think of a color space using three orthogonal axes of the R axis, the G axis, and the B axis. When this is done, all the RGB image data can definitely be displayed correlated to coordinate points within the color space. From this, if the R axis, the G axis, and the B axis are respectively subdivided and a large number of grid points are set within the color space, each of the grid points can be thought of as representing the RGB image data, and it is possible to correlate the tone values of each color C, M, Y, and K corresponding to each RGB image data to each grid point. The LUT can be thought of as a three dimensional number chart in which is correlated and stored the tone values of each color C, M, Y, and K to the grid points provided within the color pace in this way. If color conversion processing is performed based on the correlation of RGB color image data and tone data of each color C, M, YU, and K stored in this kind of LUT, it is possible to rapidly convert RGB color image data to tone data of each color C, M, Y, and K.

When tone data of each color C, M, Y, and K is obtained in this way, the computer 100 starts the tone number conversion process (step S106). The tone number conversion process is the following kind of process. The image data obtained by the color conversion process, if the data length is 1 byte, is tone data for which values can be taken from tone value 0 to tone value 255 for each pixel. In comparison to this, the printer displays images by forming dots, so for each pixel, it is only possible to have either state of “dots are formed” or “dots are not formed.” In light of this, instead of changing the tone value for each pixel, with this kind of printer, images are expressed by changing the density of dots formed within a specified area. The tone number conversion process is a process that, to generate dots at a suitable density according to the tone value of the tone data, decides the presence or absence of dot formation for each pixel.

As a method of generating dots at a suitable density according to the tone values, various methods are known such as the error diffusion method and the dither method, but with the Tone number conversion process of this embodiment, the method called the dither method is used. The dither method of this embodiment is a method that decides the presence or absence of dot formation for each pixel by comparing the threshold value set in the dither matrix and the tone value of the image data for each pixel. Following is a simple description of the principle of deciding on the presence or absence of dot formation using the dither method.

FIG. 20 is an explanatory drawing that conceptually shows an example of part of a dither matrix. The matrix shown in the drawing randomly stores threshold values selected thoroughly from a tone value range of 1 to 255 for a total of 8192 pixels, with 128 pixels in the horizontal direction (main scan direction) and 64 pixels in the vertical direction (Sub-scan direction). Here, selecting from a range of 1 to 255 for the tone value of the threshold value with this embodiment is because in addition to having the image data as 1 byte data that can take tone values from values 0 to 255, when the image data tone value and the threshold value are equal, it is decided that a dot is formed at that pixel.

Specifically, when dot formation is limited to pixels for which the image data tone value is greater than the threshold value (specifically, dots are not formed on pixels for which the tone value and threshold value are equal), dots are definitely not formed at pixels having threshold values of the same value as the largest tone value that the image data can have. To avoid this situation, the range that the threshold values can have is made to be a range that excludes the maximum tone value from the range that the image data can have. Conversely, when dots are also formed on pixels for which the image data tone value and the threshold value are equal, dots are always formed at pixels having a threshold value of the same value as the minimum tone value that the image data has. To avoid this situation, the range that the threshold values can have is made to be a range excluding the minimum tone value from the range that the image data can have. With this embodiment, the tone values that the image data can have is from 0 to 255, and since dots are formed at pixels for which the image data and the threshold value are equal, the range that the threshold values can have is set to 1 to 255. Note that the size of the dither matrix is not limited to the kind of size shown by example in FIG. 20, but can also be various sizes including a matrix for which the vertical and horizontal pixel count is the same.

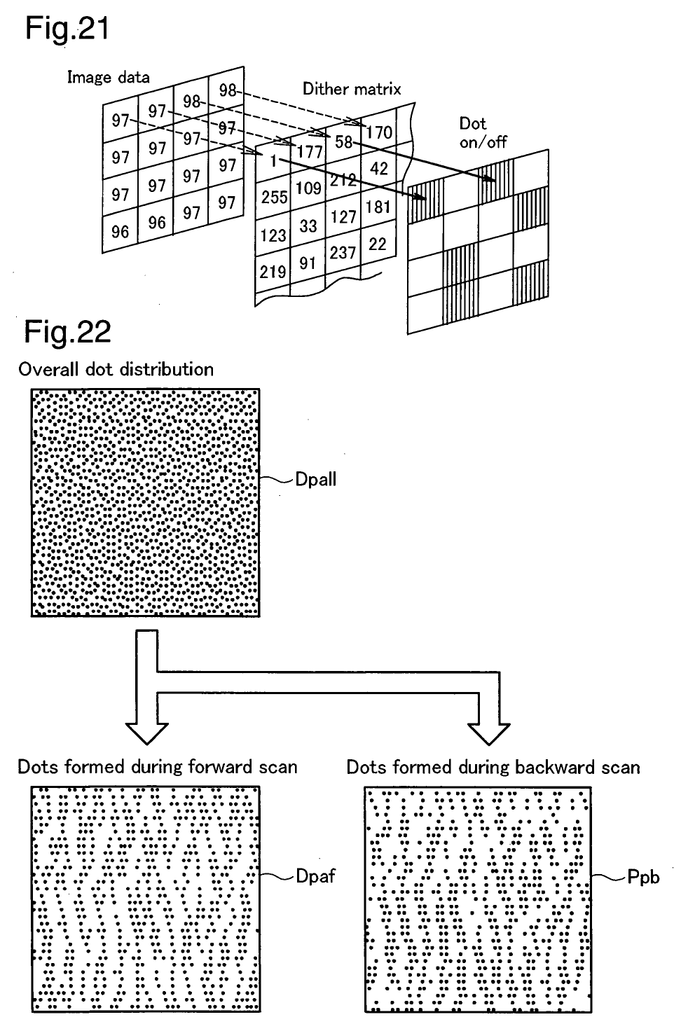

FIG. 21 is an explanatory drawing that conceptually shows the state of deciding the presence or absence of dot formation for each pixel while referring to the dither matrix. When deciding on the presence or absence of dot formation, first, a pixel for deciding about is selected, and the tone value of the image data for that pixel and the threshold value stored at the position corresponding in the dither matrix are compared. The fine dotted line arrow shown in FIG. 21 typically represents the comparison for each pixel of the tone value of the image data and the threshold value stored in the dither matrix. For example, for the pixel in the upper left corner of the image data, the threshold value of the image data is 97, and the threshold value of the dither matrix is 1, so it is decided that dots are formed at this pixel. The arrow shown by the solid line in FIG. 21 typically represents the state of it being decided that dots are formed in this pixel, and of the decision results being written to memory. Meanwhile, for the pixel that is adjacent at the right of this pixel, the tone value of the image data is 97, and the threshold value of the dither matrix is 177, and since the threshold value is larger, it is decided that dots are not formed at this pixel, With the dither method, by deciding whether or not to form dots for each pixel while referencing the dither matrix in this way, image data is converted to data representing the presence or absence of dot formation for each pixel. In this way, if using the dither method, it is possible to decide the presence or absence of dot formation for each pixel with a simple process of comparing the tone value of the image data and the threshold value set in the dither matrix, so it is possible to rapidly implement the tone number conversion process.

Also, when the image data tone value is determined, as is clear from the fact that whether or not dots are formed on each pixel is determined by the threshold value set in the dither matrix, with the dither method, it is possible to actively control the dot generating status by the threshold value set in the dither matrix. With the tone number conversion process of this embodiment, using this kind of feature of the dither method, by deciding on the presence or absence of dot formation for each pixel using the dither matrix having the special characteristics described later, even in cases when there is dot formation position misalignment between dots formed during forward scan and dots formed during backward scan when doing bidirectional printing, it is possible to suppress to a minimum the degradation of image quality due to this. The principle of being able to suppress to a minimum the image quality degradation and the characteristics provided with a dither matrix capable of this are described in detail later.

When the tone number conversion process ends and data representing the presence or absence of dot formation for each pixel is obtained from the tone data of each color C, M, Y, and K, this time, the interlace process starts (step S108). The interlace process is a process that realigns the sequence of transfer of image data converted to the expression format according to the presence or absence of dot formation to the color printer 200 while considering the sequence by which dots are actually formed on the printing paper. The computer 100, after realigning the image data by performing the interlace process, outputs the finally obtained data as control data to the color printer 200 (step S110).

The color printer 200 prints images by forming dots on the printing paper according to the control data supplied from the computer 100 in this way. Specifically, as described previously using FIG. 3, the main scan and the Sub-scan of the carriage 240 are performed by driving the carriage motor 230 and the paper feed motor 235, and the head 241 is driven based on the dot data to match these movements, and ink drops are sprayed. As a result, suitable color ink dots are formed at suitable positions and an image is printed.

The color printer 200 described above forms dots while moving the carriage 240 back and forth to print images, so if dots are formed not only during the forward scan of the carriage 240 but also during the backward scan, it is possible to rapidly print images. It makes sense that when performing this kind of bidirectional printing, when dot formation position misalignment occurs between dots formed during the forward scan of the carriage 240 and the dots formed during the backward scan, the image quality will be degraded. In light of this, to avoid this kind of situation, a normal color printer is made to be able to adjust with good precision the timing of forming dots for at least one of during forward scan or backward scan. Because of this, it is possible to match the position at which dots are formed during the forward scan and the position at which dots are formed during the backward scan, and it is possible to rapidly print images with high image quality without degradation of the image quality even when bidirectional printing is performed. However, on the other hand, because it is possible to adjust with good precision the timing of forming dots, a dedicated adjustment mechanism or adjustment program is necessary, and there is a tendency for the color printer to become more complex and larger.

To avoid the occurrence of this kind of problem, with the computer 100 of this embodiment, even when there is a slight displacement of the dot formation position during the forward scan and the backward scan, the presence or absence of dot formation is decided using a dither matrix that makes it possible to suppress to a minimum the effect on image quality. If the presence or absence of dot formation for each pixel is decided by referencing this kind of dither matrix, even if there is slight displacement of the dot formation positions between the forward scan and the backward scan, there is no significant effect on the image quality. Because of this, it is not necessary to adjust with high precision the dot formation position, and it is possible to use simple items for the mechanism and control contents for adjustment, so it is possible to avoid the color printer from becoming needlessly large and complex. Following, the principle that makes this possible is described, and after that, a simple description is given of one method for generating this kind of dither matrix.

D. Principle of Suppressing Degradation of Image Quality Due to Dot Position Misalignment

The invention of this application was completed with the discovery of new findings regarding images formed using the dither matrix as the beginning. In light of this, first, the findings we newly discovered as the beginning of the invention of this application are explained.

FIG. 22 is an explanatory drawing showing the findings that became the beginning of the invention of this application. Overall dot distribution Dpall shows an expanded view of the state of dots being formed at a specified density for forming images of certain tone values. As shown in Overall dot distribution Dpall, to obtain the optimal image quality image, it is necessary to form dots in a state dispersed as thoroughly as possible.

To form dots in a thoroughly dispersed state in this way, it is known that it is possible to reference a dither matrix having so-called blue noise characteristics to decide the presence or absence of dot formation. Here, a dither matrix having blue noise characteristics means a matrix like the following. Specifically, it means a dither matrix for which while dots are formed irregularly, the spatial frequency component of the set threshold value has the largest component in a high frequency range for which one cycle is two pixels or less. Note that bright (high brightness level) images and the like can also be cases when dots are formed in regular patterns near a specific brightness level.

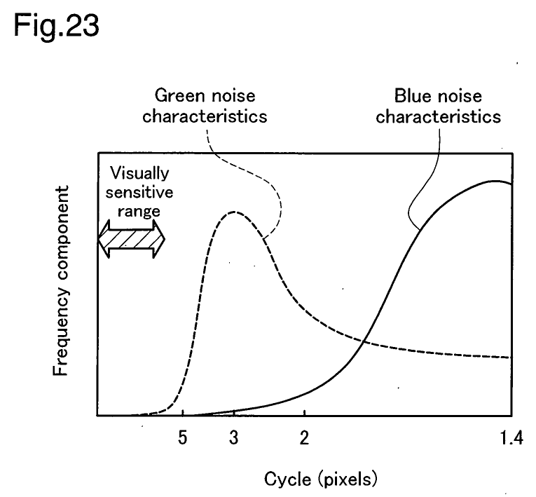

FIG. 23 is an explanatory drawing that conceptually shows an example of the spatial frequency characteristics of the threshold values set for each pixel of a dither matrix having blue noise characteristics (following, this may also be called a blue noise matrix). Note that with FIG. 23, in addition to the blue noise matrix spatial frequency characteristics, there is also a display regarding the spatial frequency characteristics of the threshold values set in a dither matrix having so called green noise characteristics (hereafter, this is also called a green noise matrix). The green noise matrix spatial frequency characteristics will be described later, but first, the blue noise matrix spatial frequency characteristics are described.

In FIG. 23, due to circumstances of display, instead of using spatial frequency for the horizontal axis, cycles are used. It goes without saying that the shorter the cycle, the higher the spatial frequency. Also, the vertical axis of FIG. 23 shows the spatial frequency component for each of the cycles. Note that the frequency components shown in the drawing indicate a state of being smoothed so that the changes are smooth to a certain degree.

The spatial frequency component of the threshold values set for the blue noise matrix is shown by example using the solid line in the drawing. As shown in the drawing, the blue noise matrix spatial frequency characteristics are characteristics having the maximum frequency component in the high frequency range for which one cycle length is two pixels or less. The threshold values of the blue noise matrix are set to have this kind of spatial frequency characteristics, so if the presence or absence of dot formation is decided based on a matrix having this kind of characteristics, then dots are formed in a state separated from each other.

From the kinds of reasons described above, if the presence or absence of dot formation for each pixel is decided while referencing a dither matrix having blue noise characteristics, as shown in the Overall dot distribution Dpall, it is possible to obtain an image with thoroughly dispersed dots. Conversely, because dots are generated dispersed thoroughly as shown in the Overall dot distribution Dpall, threshold values adjusted so as to have blue noise characteristics are set in the dither matrix.

Note that here, the spatial frequency characteristics of the threshold values set in the green noise matrix shown in FIG. 23 are described. The dotted line curve shown in FIG. 23 shows an example of green noise matrix spatial frequency characteristics. As shown in the drawing, green noise matrix spatial frequency characteristics are characteristics having the largest frequency component in the medium frequency range for which the length of one cycle is from two pixels to ten or more pixels. The green noise matrix threshold values are set so as to have this kind of spatial frequency characteristics, so when the presence or absence of dot formation for each pixel is decided while referencing a dither matrix having green noise characteristics, while dots are formed adjacent in several dot units, overall, the dot group is formed in a dispersed state. As with a so-called laser printer or the like, with a printer for which stable formation of fine dots of approximately one pixel is difficult, by deciding the presence or absence of dot formation while referencing this kind of green noise matrix, it is possible to suppress the occurrence of isolated dots. As a result, it becomes possible to rapidly output images with stable image quality. Conversely, threshold values adjusted to have green noise characteristics are set in the dither matrix referenced when deciding the presence or absence of dot formation with a laser printer or the like.

As described above, with an inkjet printer like the color printer 200, a dither matrix having blue noise characteristics is used, and therefore, as shown in the Overall dot distribution Dpall, the obtained image is an image with thoroughly dispersed dots. However, when this image is viewed with the dots formed during forward scan of the head separated from the dots formed during the backward scan, we found that the images made only by dots formed during the forward scan (forward scan images) and the images made only by dots formed during the backward scan (backward scan images) do not necessarily have the dots thoroughly dispersed. Dots formed during forward scan Dpf is an image obtained by extracting only the dots formed during the forward scan from the image shown in the Overall dot distribution Dpall. Also, Dots formed during backward scan Dpb is an image obtained by extracting only the dots formed during the backward scan from the image shown in the Overall dot distribution Dpall.

As shown in the drawing, if the dots formed by both the back and forth movements are matched, as shown in the Overall dot distribution Dpall, regardless of the fact that the dots are formed thoroughly, the image of only the dots formed during the forward scan shown in the dots formed during forward scan Dpf or the image of only the dots formed during the backward scan shown in the dots formed during backward scan Dpb are both generated in a state with the dots unbalanced.

In this way, though it is unexpected that there would be a big difference in tendency, if we think in the following way, it seems that this is a phenomenon that occurs half by necessity. Specifically, as described previously, the dot distribution status depends on the setting of the threshold values of the dither matrix, and the dither matrix threshold values are set with special generation of the distribution of the threshold values to have blue noise characteristics so that the dots are dispersed well. Here, among the dither matrix threshold values, threshold values of pixels for which dots are formed during the forward scan or threshold values of pixels for which dots are formed during the backward scan are taken, and with no consideration such has having the distribution of the respective threshold values having blue noise characteristics, the fact that the distribution of these threshold values, in contrast to the blue noise characteristics, have characteristics having a large frequency component in the long frequency range, seems half necessary (see FIG. 23). Also, for a dither matrix having green noise characteristics as well, when we consider that this is a matrix specially set for the threshold value distribution to have green noise characteristics, the threshold values of the pixels for which dots are formed during the forward scan or the backward scan are considered to have a large frequency component on a longer cycle side than the cycle for which the green noise matrix has a large frequency component (see FIG. 23). In the end, when the threshold values of pixels for which dots are formed during the forward scan or the threshold values of pixels for which dots are formed during the backward scan are taken from the dither matrix having blue noise characteristics, the distribution of those threshold values have large frequency components in the Visually sensitive range. Because of this, for example, even when images have dots thoroughly dispersed, when only dots formed during the forward scan or only dots formed during the backward scan are removed, the obtained images respectively are considered to be images for which the dots have unbalance occur such as shown in the dots formed during forward scan Dpf and the dots formed during backward scan Dpb. Specifically, the phenomenon shown in FIG. 22 is not a special phenomenon that occurs with a specific dither matrix, but rather can be thought of as the same phenomenon that occurs with most dither matrixes.

Considering the kind of new findings noted above and the considerations for these findings, studies were done for other dither matrixes as well. With the study, to quantitatively evaluate the results, an index called the granularity index was used. In light of this, before describing the study results, we will give a brief description of the granularity index.

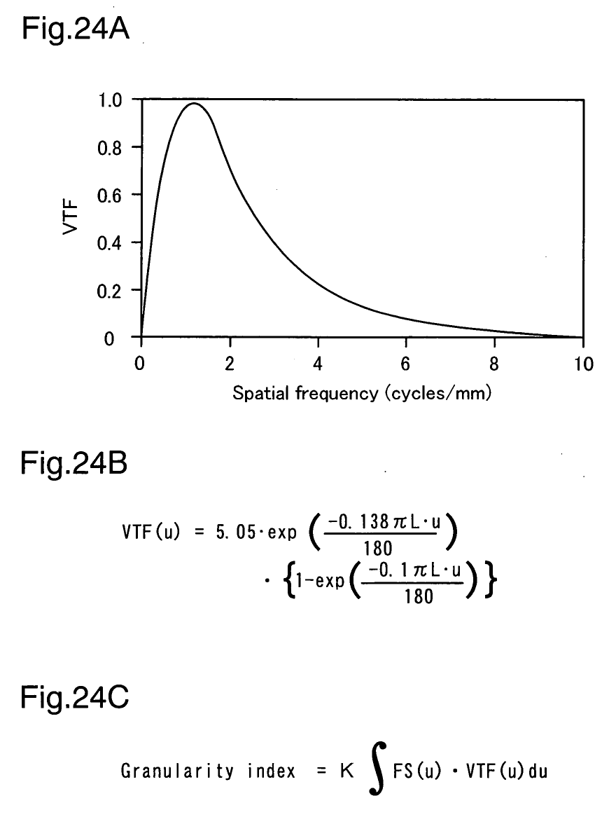

FIGS. 24A to 24C is an explanatory drawing that conceptually shows the sensitivity characteristics VTF (Visual Transfer Function) to the visual spatial frequency that humans have. As shown in the drawing, human vision has a spatial frequency showing a high sensitivity, and there is a characteristic of the sensitivity decreasing gradually as the spatial frequency increases. It is also known that there is a characteristic of the vision sensitivity decreasing also in ranges for which the spatial frequency is extremely low. An example of this kind of human vision sensitivity characteristic is shown in FIG. 24A. Various experimental formulae have been proposed as an experimental formula for giving this kind of sensitivity characteristic, but a representative experimental formula is shown in FIG. 24B. Note that the variable L in FIG. 24B represents the observation distance, and the variable u represents the spatial frequency.

Based on this kind of visual sensitivity characteristic VTF, it is possible to think of a granularity index (specifically, an index representing how easy it is for a dot to stand out). Now, we will assume that a certain image has been Fourier transformed to obtain a power spectrum. If that power spectrum happens to contain a large frequency component, that doesn't necessarily mean that that image will immediately be an image for which the dots stand out. This is because as described previously using FIG. 24A, if that frequency is in the low range of human visual sensitivity, for example even if it has a large frequency component, the dots do not stand out that much. Conversely, with frequencies in the high range of human visual sensitivity, for example even when there are only relatively low frequency components, for the entity doing the viewing, there are cases when the dots are sensed to stand out. From this fact, the image is Fourier transformed to obtain a power spectrum FS, the obtained power spectrum FS is weighted to correlate to the human visual sensitivity characteristic VTF, and if integration is done with each spatial frequency, then an index indicating whether or not a human senses the dots as standing out or not is obtained. The granularity index is an index obtained in this way, and can be calculated by the calculation formula shown in FIG. 24C. Note that the coefficient K in FIG. 24C is a coefficient for matching the obtained value with the human visual sense.

To confirm that the phenomenon described previously using FIG. 22 is not a special phenomenon that occurs with a specific dither matrix, but rather occurs also with most dither matrixes, the following kind of study was performed on various dither matrixes having blue noise characteristics. First, from among the dots formed by bidirectional printing, images made only by dots formed during the forward scan such as shown in the dots formed during forward scan Dpf (forward scan images) are obtained. Next, the granularity index of the obtained images is calculated. This kind of operation was performed for various dither matrixes while changing the image tone values.

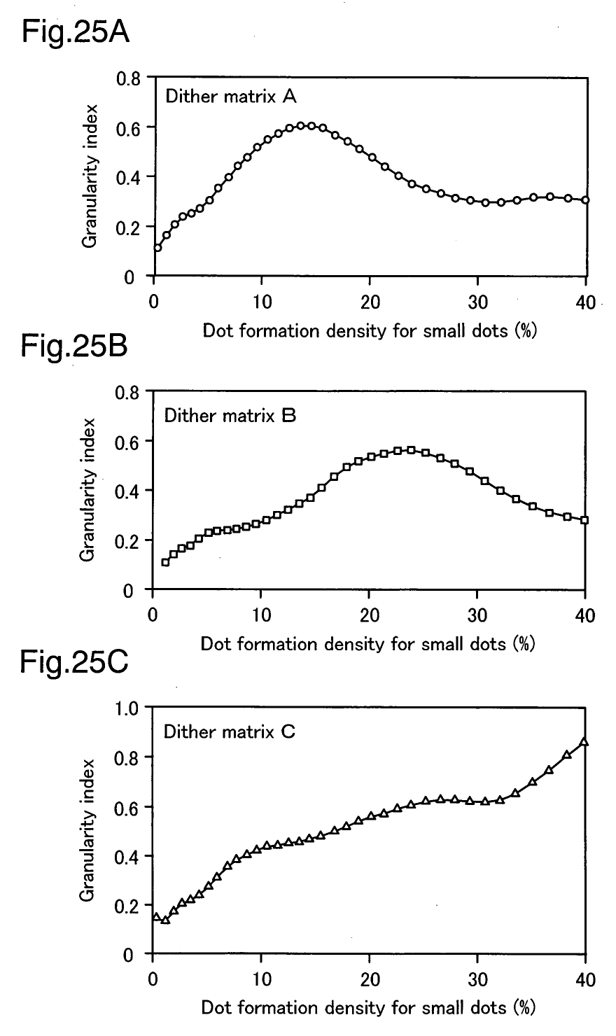

FIGS. 25A to 25C are explanatory drawings showing the results of studying the granularity index of forward scan images for various dither matrixes having blue noise characteristics. Shown in FIGS. 25A to 25C are only the results obtained for three dither matrixes with different resolutions. The dither matrix A shown in FIG. 25A is a dither matrix for printing at a main scan direction resolution of 1440 dpi and Sub-scan direction resolution of 720 dpi, and the dither matrix B shown in FIG. 25B is a dither matrix used for printing at a resolution of 1440 dpi for both the main scan direction and the Sub-scan direction. Also, the dither matrix C shown in FIG. 25C is a dither matrix for printing in the main scan direction at a resolution of 720 dpi and in the Sub-scan direction at a resolution of 1440 dpi. Note that in FIGS. 25A to 25C, the horizontal axis is displayed using the small dot formation density, and the areas for which the displayed small dot formation density is 40% or less correlate to areas up to before the intermediate gradation area from the highlight area for which it is considered that the dots stand out relatively easily.

Regardless of the fact that the three forward scan images shown in FIGS. 25A to 25C are generated from individually created dither matrixes for printing respectively at different resolutions, each has an area for which the granularity index is degraded (specifically, an area in which the dots stand out easily). In this kind of area, the forward scan image can be thought of as the dots generating imbalance as shown in the dots formed during forward scan Dpf. In the end, all of the three dither matrixes shown in FIGS. 25A to 25C have blue noise characteristics, and therefore, regardless of the fact that the images formed using bidirectional printing have dots formed without imbalance, in at least part of the gradation area, the forward scan image or the backward scan image has dot imbalance occur. From this, the phenomenon described previously using FIG. 22 can be thought of not as a special phenomenon that occurs with a specific dither matrix but rather as a general phenomenon that occurs with most dither matrixes. Then, when we consider the occurrence of dot imbalance with either forward scan images or backward scan images in this way, this can be thought of as possibly having an effect on the image quality degradation due to dot position misalignment during bidirectional printing. In light of this, we tried studying to see whether or not any kind of correlation can be seen between the granularity index of images formed with an intentional displacement in the dot formation position during bidirectional printing (position misalignment image) and the granularity index of forward scan images.

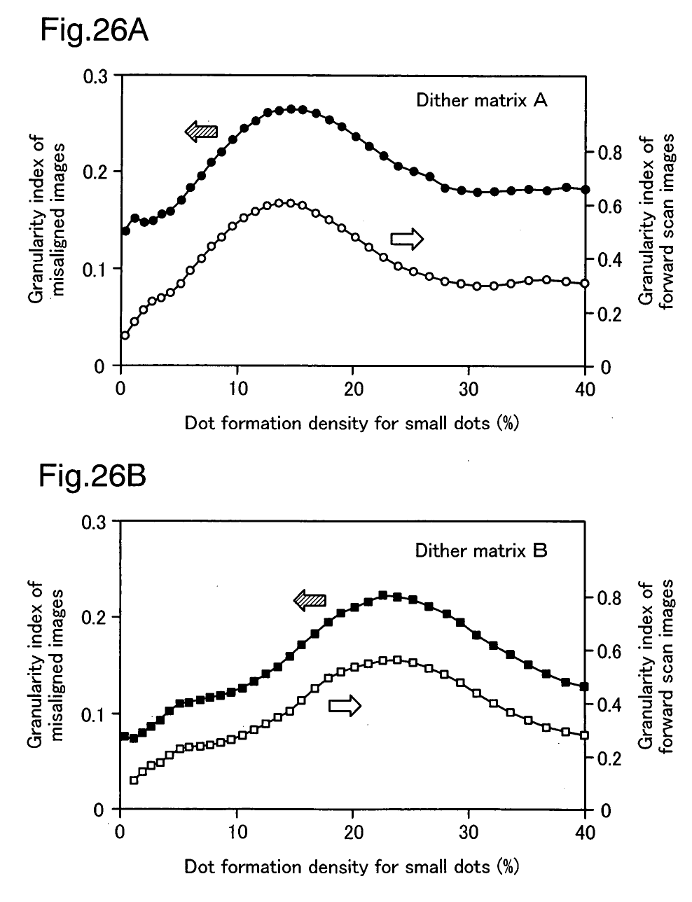

FIGS. 26A and 26B are explanatory drawings showing the results of studying the correlation coefficient between the position misalignment image granularity index and the forward scan image granularity index. FIG. 26A shows the results of a study on the dither matrix A shown in FIG. 25A, and in the drawing, the black circles represent the position misalignment image granularity index and the white circles in the drawing represent the granularity index for the forward scan image. Also, FIG. 26B shows the results of a study on the dither matrix B shown in FIG. 25B, and the black squares represent the position misalignment image granularity index while the white squares represent the forward image granularity index. As is clear from FIGS. 26A and 26B, for any of the dither matrixes, a surprisingly strong correlation is seen between the position misalignment image granularity index and the forward image granularity index. From this fact, for the phenomenon of the image quality being degraded by the dot position misalignment during bidirectional printing, the fact that the bidirectional image dot imbalance becomes marked due to displacement of the relative position between the forward scan images and the backward scan images can be considered to be one significant factor. Conversely, if the dot imbalance between the forward scan images and the backward scan images is reduced, for example even when dot position misalignment occurs during bidirectional printing, it is thought that it is possible to suppress image quality degradation.

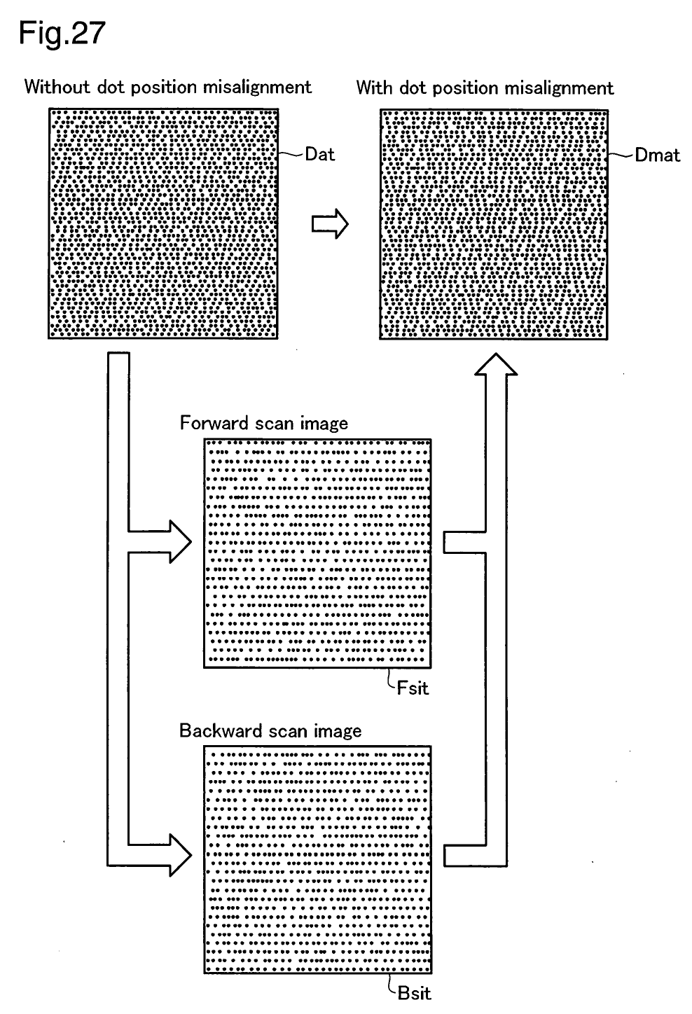

FIG. 27 is an explanatory drawing showing that it is possible to suppress the image quality degradation when dot position misalignment occurs during bidirectional printing if the dot imbalance is reduced for images during forward scan and images during backward scan. Dot pattern Dat and dot pattern Dmat show a comparison of an image for which bidirectional printing was performed in a state without dot position misalignment and an image printed in a state with intentional displacement by a specified volume of the dot formation position. Also, shown respectively in FIG. 27, Forward scan image Fsit and Backward scan image Bsit are images obtained by breaking down into an image made only by dots formed during the forward scan of the head (forward scan image) and an image made only by dots formed during the backward scan (backward scan image).

As shown in the forward scan image Fsit and the backward scan image Bsit, the forward scan images and the backward scan images are both images for which the dots are dispersed thoroughly. Also, as shown in the forward scan image Fsit, in the state with no dot position misalignment, images obtained by synthesizing the forward scan images and backward scan images (specifically, images obtained with bidirectional printing) are also images for which the dots are dispersed thoroughly. In this way, not just images obtained by performing bidirectional printing, but also when broken down into forward scan images and backward images, images that have the dots dispersed thoroughly with the respective images can be obtained by deciding the presence or absence of dot formation while referencing a dither matrix having the kind of characteristics described later in the tone number conversion process of FIG. 18. Then, the backward scan image Bsit correlates to an image for which this kind of forward scan image and backward scan image are overlapped in a state displaced by a specified amount.

If the image without position misalignment (left side image) shown in the forward scan image Fsit and the image with position misalignment (right side image) are compared, by the dot position being displaced, the right side image has its dots stand out slightly more easily than the left side image with no displacement, but we can understand that this is not at a level that greatly degrades the image quality. This is thought to show that even when broken down into forward scan images and backward scan images, if dots are generated so that the dots are dispersed thoroughly, for example even when dot position misalignment occurs during bidirectional printing, it is possible to greatly suppress degradation of image quality due to this.

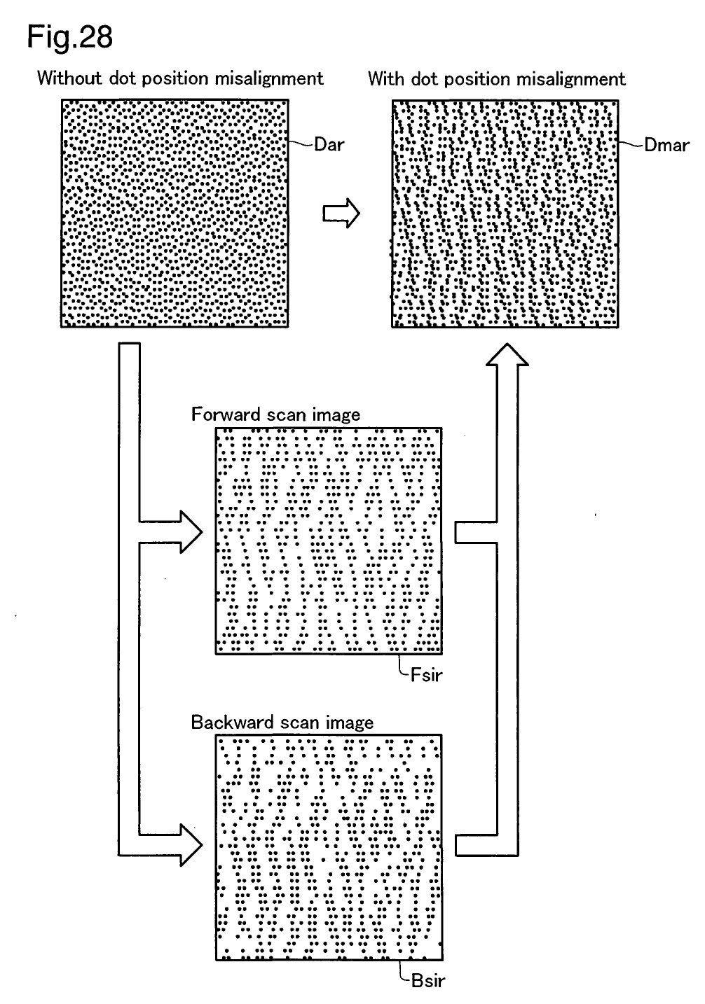

As a reference, with the image formed using a typical dither matrix, we checked to what degree image quality degraded when dot position misalignment occurred by the same amount as the case shown in FIG. 27. FIG. 28 is an explanatory drawing showing degradation of the image quality due to the presence or absence of dot position misalignment with the image formed by a typical dither matrix. The image without position misalignment (left side image) shown in Dot pattern Dar is an image for which the forward scan image and backward scan image shown in FIG. 22 are overlapped without any position misalignment. Also, the image with position misalignment shown in Dot pattern Dar is an image for which the forward scan image and the backward scan image are overlapped in a state with the position displaced by the same amount as the case shown in FIG. 27. Note that in the forward scan image Fsir and the backward scan image Bsir, the respective forward scan images and backward scan images are shown.

As is clear from FIG. 28, when dots are generated with imbalance with the forward scan image and the backward scan image, it is possible to confirm that when the dot formation positions are displaced during bidirectional printing, there is great degradation of the image quality when the image quality is greatly degraded. Also, when FIG. 27 and FIG. 28 are compared, by thoroughly dispersing the dots with the forward scan image and the backward scan image, it is possible to understand that the image quality degradation due to dot position misalignment can be dramatically improved.

With the color printer 200 of this embodiment, based on this kind of principle, it is possible to suppress to a minimum the image quality degradation due to dot position misalignment during bidirectional printing. Because of this, during bidirectional printing, even when the formation positions of the dots formed during forward scan and the dots formed during backward scan are not matched with high precision, there is no degradation of image quality. As a result, there is no need for a mechanism or control program for adjusting with good precision the dot position misalignment, so it is possible to use a simple constitution for the printer. Furthermore, it is possible to reduce the precision required for the mechanism for moving the head back and forth as well, and this point also makes it possible to simplify the printer constitution.

E. Dither Matrix Generating Method

Next, a simple description is given of an example of a method of generating a dither matrix to be referenced by the tone number conversion process of this embodiment.

Specifically, with the tone number conversion process of this embodiment, for dots formed during the forward scan, for dots formed during the backward scan, and furthermore, for combinations of these dots, dots are generated in a thoroughly dispersed state, so gradation conversion processing is performed while referencing a dither matrix having the following two kinds of characteristics.

“First Characteristic”: The dither matrix pixel positions can be classified into first pixel position groups and second pixel position groups. Here, the first pixel position and the second pixel position mean pixel positions having a mutual relationship such that when dots are formed by either the forward scan or the backward scan, the other has dots formed by the other.

“Second Characteristic”: The dither matrix and a matrix for which the threshold values set for the first pixel position are removed from that dither matrix (first pixel position matrix), and a matrix for which the threshold values set for the second pixel positions are removed (second pixel position matrix) all have either blue noise characteristics or green noise characteristics. Here, a “dither matrix having blue noise characteristics” means the following kind of matrix. Specifically, it means a dither matrix for which dots are generated irregularly and the spatial frequency component of the set threshold values have the largest component in the medium frequency range for which one cycle is from two pixels to ten or more pixels. Also, a “dither matrix having green noise characteristics” means a dither matrix for which dots are formed irregularly and the spatial frequency component of the set threshold values have the largest component in the medium frequency range for which one cycle has from two pixels to ten or more pixels. Note that if these dither matrixes are near a specific brightness, it is also acceptable if there are dots formed in a regular pattern.

As described previously, dither matrixes having these kind of characteristics can definitely not be generated by coincidence, so a brief description is given of an example of a method for generating this kind of dither matrix.

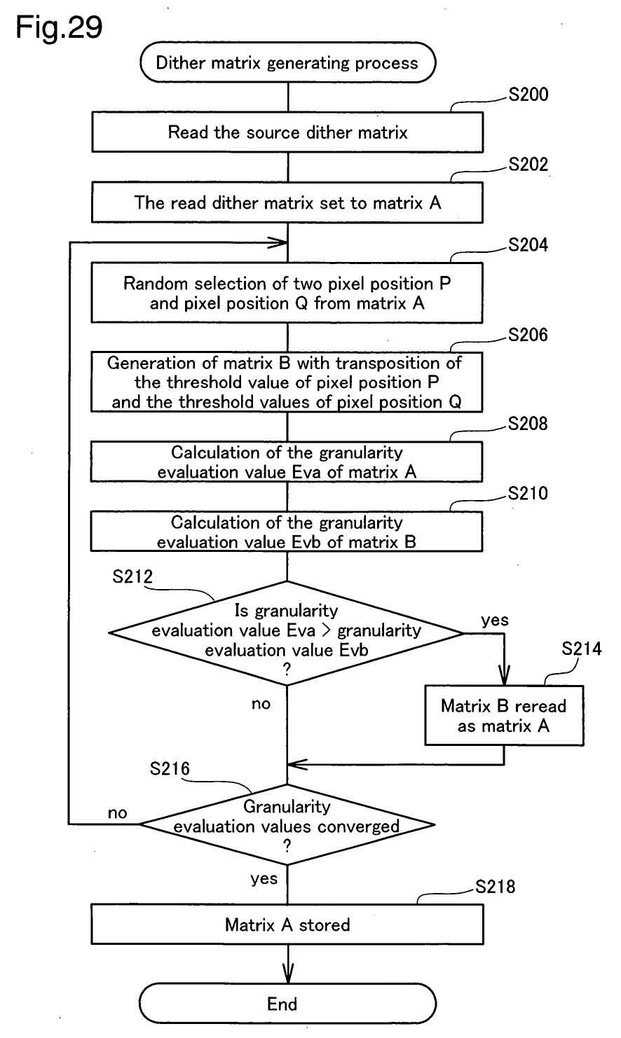

FIG. 29 is a flow chart showing the flow of the process of generating dither matrixes referenced with the tone number conversion process of this embodiment. Note that here, with an existing dither matrix having blue noise characteristics as a source, so that the “first characteristics” and “second characteristics” described above can be obtained, described is a method to which correction is added. It makes sense that rather than correcting the matrix that is the source, that it is also possible to generate first from a dither matrix having the “first characteristics” and “second characteristics.” Also, here, described is a case when a matrix having blue noise characteristics is the source, but it is also possible to obtain a dither matrix having the characteristics noted above by working in about the same manner when using a dither matrix having green noise characteristics as the source as well.

When the dither matrix generating process starts, first, the dither matrix that is the source is read (step S200). This matrix overall has blue noise characteristics, but the first pixel position matrix (the matrix for which the threshold values set at the first pixel position are removed from the dither matrix) and the second pixel position matrix (the matrix for which the threshold values set at the second pixel position are removed from the dither matrix) are both matrixes that do not have blue noise characteristics. Note that as described previously, the first pixel position and the second pixel position mean pixel positions in a mutual relationship for which when dots are formed either during forward scan or backward scan, the other has dots formed by the other.

Next, the read matrix is set as matrix A (step S202). Then, from the dither matrix A, two pixel positions (pixel position P and pixel position Q) are randomly selected (step S204), the threshold value set at the selected pixel position P and the threshold value set at the selected pixel position Q are transposed, and the obtained matrix is used as matrix B (step S206).

Next, the granularity evaluation value Eva for the matrix A is calculated (step S208). Here, the granularity evaluation value means an evaluation value obtained as follows. First, using the dither method on 256 images of tone values 0 to 255, 256 images are obtained expressed by the presence or absence of dot formation. Next, each image is broken down into forward scan images and backward scan images. As a result, for each of the tone values from 0 to 255, obtained are the forward scan image, the backward scan image, and an image for which these are overlapped (total image). For the 768 (=256×3) images obtained in this way, after calculation of the granularity index described previously using FIG. 11, the value obtained by finding the average value of these is used as the granularity evaluation value. Note that when calculating the granularity evaluation value, rather than simply using an arithmetic mean of the 768 granularity indices, it is also possible to take a weighted average respectively of the forward scan image, the backward scan image, and the total image. Alternatively, for a specific tone value (e.g. a low tone range for which it is said that dots stand out relatively easily), it is also possible to apply a large weighting coefficient and take the average. At step S208 of FIG. 29, for the matrix A, this kind of granularity evaluation value is found, and the obtained value is used as the granularity evaluation value Eva.

When the granularity evaluation value Eva is obtained for the matrix A, the granularity evaluation value Evb is calculated in the same manner for the matrix B as well (step S210). Next, the granularity evaluation value Eva for the matrix A and the granularity evaluation value Evb for the matrix B are compared (step S212). Then, when it is determined that the granularity evaluation value Eva is bigger (step S212: yes), the matrix B for which the threshold values set in the two pixel positions are transposed is through to have more desirable characteristics than the matrix A which is the source. In light of this, in this case, the matrix B is reread as matrix A (step S214). Meanwhile, when it is decided that the granularity evaluation value Evb of the matrix B is larger than the granularity evaluation value Eva of the matrix A (step S212: no), then matrix is not reread.

In this way, only in the case when it is determined that the granularity evaluation value Eva of the matrix A is larger than the granularity evaluation value Evb of the matrix B, when the operation of rereading the matrix B as the matrix A, a determination is made of whether or not the granularity evaluation values are converged (step S216). Specifically, the dither matrix set as the source has the dots formed during the forward scan and the dots formed during the backward scan generated with imbalance, so immediately after starting the kind of operation noted above, a large value is taken for the granularity evaluation value. However, by transposing the threshold values set in the two pixel position locations, when a smaller granularity evaluation value is obtained, if the matrix for which the threshold value is transposed is used, and the operation described above is further repeated for this matrix, the obtained granularity evaluation value becomes smaller, and it is thought that over time it becomes stable at a certain value. At step S216, a determination is made of whether or not the granularity evaluation value has stabilized, or said another way, whether or not it can be thought of as having reached bottom. For whether or not the granularity evaluation values have converged, for example, when the granularity evaluation value Evb of the matrix B is smaller than the granularity evaluation value Eva of the matrix A, the decrease volume of the granularity evaluation value is obtained, and if this decrease volume is a fixed value or less that is stable across a plurality of operations, it can be determined that the granularity evaluation values have converged.

Then, when it is determined that the granularity evaluation values have not converged (step S216: no), the process backwards to step S204, and after selecting two new pixel positions, the subsequent series of operations is repeated. While repeating this kind of operation, over time, the granularity evaluation values converge, and when it is determined that the granularity evaluation values have converged (step S216: yes), the matrix A at that time becomes a dither matrix having the previously described “first characteristics” and “second characteristics.” In light of this, this matrix A is stored (step S218), and the dither matrix generating process shown in FIG. 29 ends.

If tone number conversion processing is performed while referencing a dither matrix obtained in this way, and a decision is made on the presence or absence of dot formation for each pixel, it goes without saying for the overall image, as well as for the forward scan images and the backward scan images, that it is possible to obtain images for which the dots are dispersed well. Because of this, for example even when there is slight displacement of the dot formation positions during bidirectional printing, it is possible to suppress to a minimum the effect on the image quality by this.

Note that with this embodiment, the granularity evaluation value Eva used to evaluate the dither matrix is calculated based on the granularity index that is the subjective evaluation value that uses the visual sensitivity characteristic VTF, but it is also possible to calculate based on the RMS granularity that is the standard deviation of the density distribution, for example.

The granularity index is a well known method and is an evaluation index used widely from the past. However, calculation of the granularity index, as described previously, means obtaining the power spectrum FS by doing Fourier transformation of an image, and it is necessary to add a weighting to the obtained power spectrum FS that correlates to the human visual sensitivity characteristics VTF, so there is the problem of the calculation volume becoming very large. Meanwhile, the RMS granularity is an objective measure representing variance of dot denseness, and this can be calculated simply just by the smoothing process using a smoothing filter set according to the resolution and calculation of the standard deviation of the dot formation density, so it is perfect for optimization processing which has many repeated calculations. In addition, use of the RMS granularity has the advantage of flexible processing being possible considering the human visual sensitivity and visual environment according to the design of the smoothing filter in comparison to the fixed process that uses the human visual sensitivity characteristics VTF.

Also, with the embodiment described above, the first pixel position and the second pixel position were described as pixel positions having a mutual relationship whereby when dots are formed by either of the forward scan or the backward scan, with the other, dots are formed by the other. Specifically, even within a row of pixels aligned in the main scan direction (this kind of pixel alignment is called a “raster”), there are cases when a first pixel position and a second pixel position are included. However, from the perspective of securing image quality during occurrence of dot position misalignment, it is preferable that the first pixel positions and the second pixel positions not be mixed within the same raster. Following is a description of the reason for this.

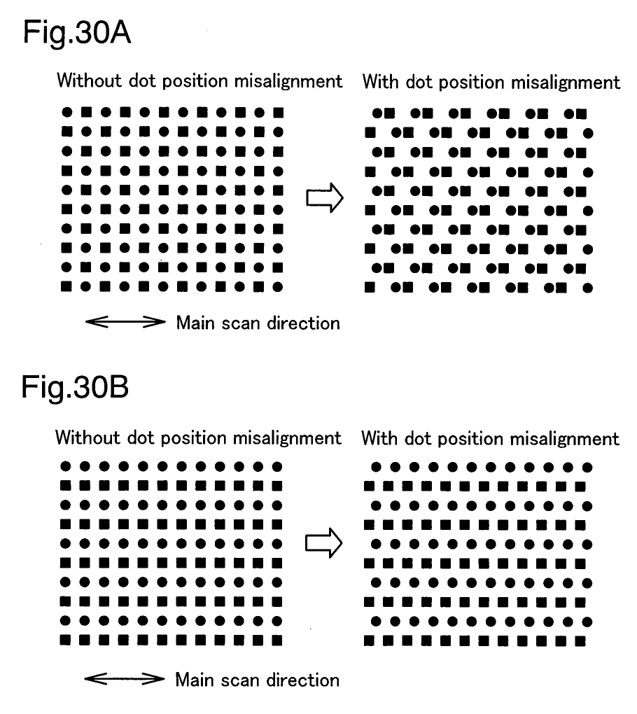

FIG. 30 is an explanatory drawing showing the reason that it is possible to ensure image quality when dot position misalignment occurs by not mixing the first pixel positions and the second pixel positions within the same raster. The black circles shown in the drawing indicate dots formed during the forward scan, and the black squares indicate dots formed during the backward scan. Specifically, if one of the black circles or black squares is set as the first pixel position, then the other is set as the second pixel position. FIG. 30A represents a state in which the first pixel position and the second pixel position are mixed in the same raster, and FIG. 30B represents a state in which the first pixel position and the second pixel position are not mixed in the same raster. Also, in the respective drawings, the drawing shown at the left side indicates an image in a state without dot position misalignment, and the drawing at the right side indicates an image in a state with dot position misalignment. As is clear from FIG. 30A, when the first pixel position and the second pixel positions are mixed in the same raster, when dot position misalignment occurs, by the distance between dots within the raster occurring at close locations and at distant locations, this degrades the image quality. In comparison to this, as shown in FIG. 30B, if the first pixel position and the second pixel position are not mixed in the same raster, for example, even when dot position misalignment occurs, there is no occurrence of the dot distance in a raster being at close locations and distant locations, and it is possible to suppress degradation of the image quality.

In addition, as shown in FIG. 30B, if the first pixel position rasters and the second pixel position rasters are arranged alternately, for example, even when dot position misalignment occurs, the dots are displaced in one direction across the subsequent rasters, and it is possible to avoid having this visually recognized, degrading the image quality.

As described above, the first pixel position dither matrix and the second pixel position dither matrix are dither matrixes having blue noise characteristics (or green noise characteristics), and in addition, if the first pixel positions and the second pixel positions are made not to be mixed within the same raster, for example even if the dot formation positions are displaced during bidirectional printing, it is possible to more effectively suppress this from causing degradation of the image quality.

### F. VARIATION EXAMPLES

Above, a number of embodiments of the invention were described, but the invention is in no way limited to these kinds of embodiments, and it is possible to embody various aspects in a scope that does not stray from the key points.

For example, the following kinds of variation examples are possible.

### F-1. First Variation Example

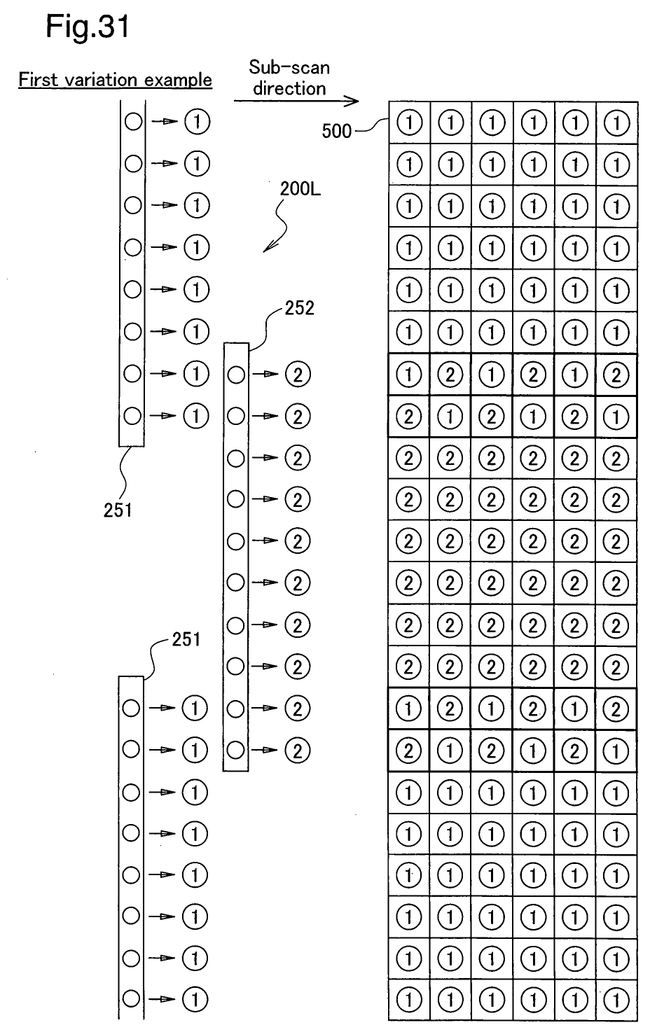

FIG. 31 is an explanatory drawing showing the printing state using a line printer 200L having a plurality of printing heads 251 and 252 for the first variation example of the invention. The printing head 251 and the printing head 252 are respectively arranged in a plurality at the upstream side and the downstream side. The line printer 200L is a printer that outputs at high speed by performing only Sub-scan feed without performing the main scan.

Shown at the right side of FIG. 31 is a dot pattern 500 formed by the line printer 200L. The numbers 1 and 2 inside the circles indicate that it is the printing head 251 or 252 that is in charge of dot formation. In specific terms, dots for which the numbers inside the circle are 1 and 2 are respectively formed by the printing head 251 and the printing head 252.

Inside the bold line of the dot pattern 500 is an overlap area at which dots are formed by both the printing head 251 and the printing head 252. The overlap area makes the connection smooth between the printing head 251 and the printing head 252, and is provided to make the difference in the dot formation position that occurs at both ends of the printing heads 251 and 252 not stand out. This is because at both ends of the printing heads 251 and 252, the individual manufacturing difference between the printing heads 251 and 252 is big, and the dot formation position difference also becomes bigger, so there is a demand to make this not stand out clearly.

In this kind of case as well, the same phenomenon as when the dot formation position is displaced between the forward scan and the backward scan as described above occurs due to the error in the mutual positional relationship of the printing heads 251 and 252, so it is possible to try to improve image quality by performing the same process as the embodiment described previously using the pixel position group formed by the printing head 251 and the pixel position group formed by the printing head 252.

### F-2. Second Variation Example

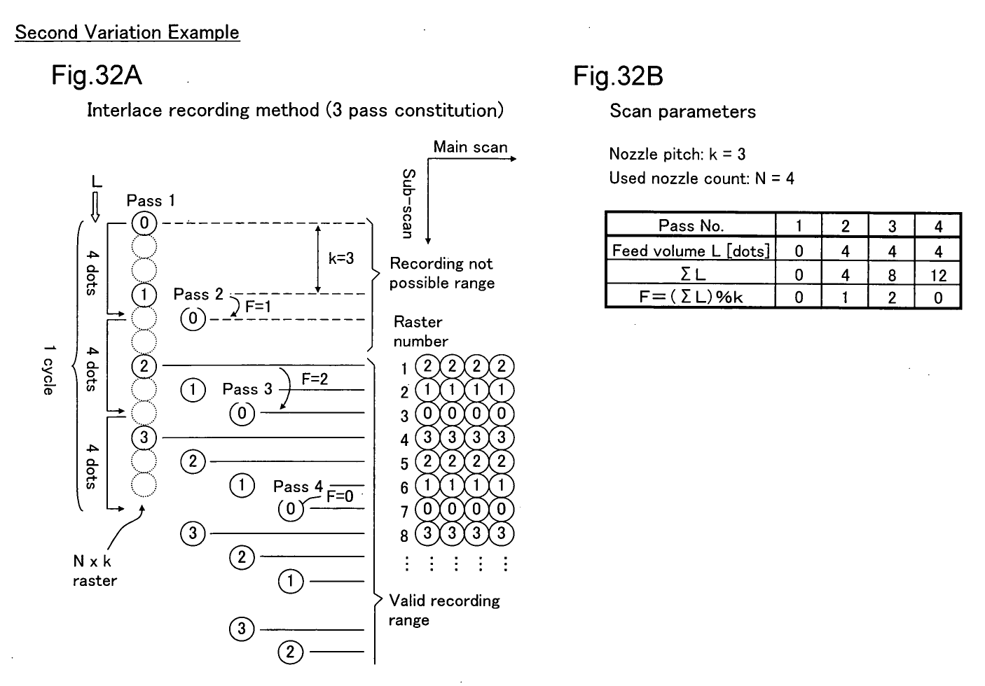

FIGS. 32A and 32B are explanatory drawings showing the state of printing using the interlace recording method for the second variation example of the invention. The interlace recording method means a recording method used when the nozzle pitch k “dots” are 2 or greater measured along the Sub-scan direction of the printing head. With the interlace recording method, a raster line that cannot be recorded between adjacent nozzles with one main scan is left, and the pixels on this raster line are recorded during another main scan. With this variation example, the main scan is also called a pass.

FIG. 32A shows an example of the Sub-scan feed when using four nozzles, and FIG. 32B shows the parameters of that dot recording method. In FIG. 32A, the solid line circles containing numbers indicate the Sub-scan direction position of the four nozzles for each pass. Here, “pass” means one main scan. The numbers 0 to 3 in the circles mean the nozzle numbers. The position of the four nozzles is sent in the Sub-scan direction each time one main scan ends.

As shown at the left end of FIG. 32A, with this example, the Sub-scan feed volume L is a fixed value of four dots. Therefore, each time a Sub-scan feed is performed, the four nozzle positions are displaced in the Sub-scan direction four dots at a time. Each nozzle has as a recording subject all the dot positions (also called “pixel positions”) on the respective raster lines in one main scan. At the right end of FIG. 32A is shown the number of the nozzle that records the dots on each raster line.

In FIG. 32B are shown the various parameters relating to this dot recording method. Included in the parameters of the dot recording method are nozzle pitch k [dots], used nozzle count N [units], and Sub-scan feed volume L [dots]. With the example in FIGS. 32A and 32B, the nozzle pitch k is three dots. The used nozzle count N is four units.

Shown in the table in FIG. 32B are the Sub-scan feed volume L for each pass, the cumulative value ΣL thereof, and the nozzle offset F. Here, the offset F is a value that, when a reference position is assumed for which the offset is 0 for a cyclical position of the nozzles for the first pass 1 (in FIGS. 32A and 32B, the position at every four dots), indicates by how many dots the nozzle position for each pass after that is separated in the Sub-scan direction from the reference position. For example, as shown in FIG. 32A, after pass 1, the nozzle position moves in the Sub-scan direction by an amount Sub-scan feed volume L (four dots). Meanwhile, the nozzle pitch k is three dots. Therefore, the offset F of the nozzles for pass 2 is 1 (see FIG. 32A). Similarly, the nozzle position for pass 3 is ΣL=8 dots moved from the initial positions, and the offset F is 2. The nozzle position for pass 4 is ΣL=12 dots moved from the initial position, and the offset F is 0. With pass 4 after three Sub-scan feeds, the nozzle offset F backwards to 0, so with three Sub-scans as one cycle, by repeating this cycle, it is possible to record all the dots on the raster line in an effective recording range.

In this way, with the second variation example, in contrast to embedding the dots with the forward scan and backward scan as described above, dots are embedded with one cycle three passes, so it is conceivable that there will be displacement of mutual positions between each pass in one cycle due to Sub-scan feed error. Because of this, it is possible that the same phenomenon will occur as when the dot formation positions are displaced with the forward scan and backward scan described above, so it is possible to try to improve the image quality using the same process as the embodiments described above with a pixel position group formed with the first pass of each cycle, a pixel position group formed with the second pass, and a pixel position group formed with the third pass.

Note that with the interlace recording method, each cycle does not necessarily embed dots with three passes, and it is also possible to constitute one cycle with two times or four times or more. In this case, it is possible to do group division for each pass that constitutes each cycle.

Also, the group division does not necessarily have to be performed on all the passes that constitute each cycle, and for example, it is also possible to constitute this to be divided into a pixel position group formed with the last pass of each cycle for which Sub-scan feed error accumulation is anticipated and a pixel position group formed with the first pass of each cycle.

### F-3. Third Variation Example

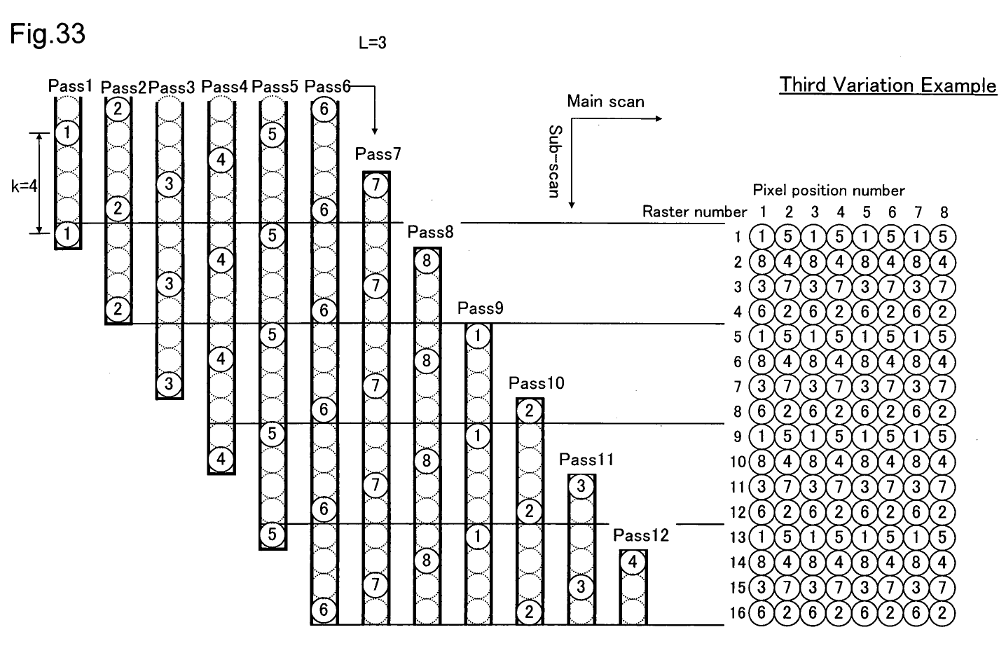

FIG. 33 is an explanatory drawing showing the state of printing using an overlap recording method for the third variation example of the invention. In FIG. 33, the solid line circles including numbers indicate positions in the Sub-scan direction of six nozzles for each pass. The numbers 1 to 8 in the solid line circles are the number of remainders after dividing the pass number by 8. The pixel position number indicates the sequence of the arrangement of pixels on each raster line.

The overlap recording method is a recording method for which each raster line is formed by a plurality of passes. With the third variation example, each raster line is formed with two passes. In specific terms, for example, the raster line for which the raster number is 1 is formed by pass 1 and pass 5, and the raster lines 2 and 3 are respectively formed by pass 8 and pass 4, and pass 3 and pass 7.

As can be seen from FIG. 33, the dot pattern constituted by the raster lines for which the raster numbers are 1 to 4 are formed by eight passes of pass 1 to pass 8, and the dot pattern constituted by the raster lines for which the raster numbers are 5 to 8 are formed by eight passes of pass 3 to pass 10. Furthermore, when we focus on the number of remainders when the pass number is divided by 8, by repeating the dot pattern constituted by the dots formed on pixels 1 to 4 by the raster number and pixel position numbers 1 to 4, we can see that all the dot patterns are formed.

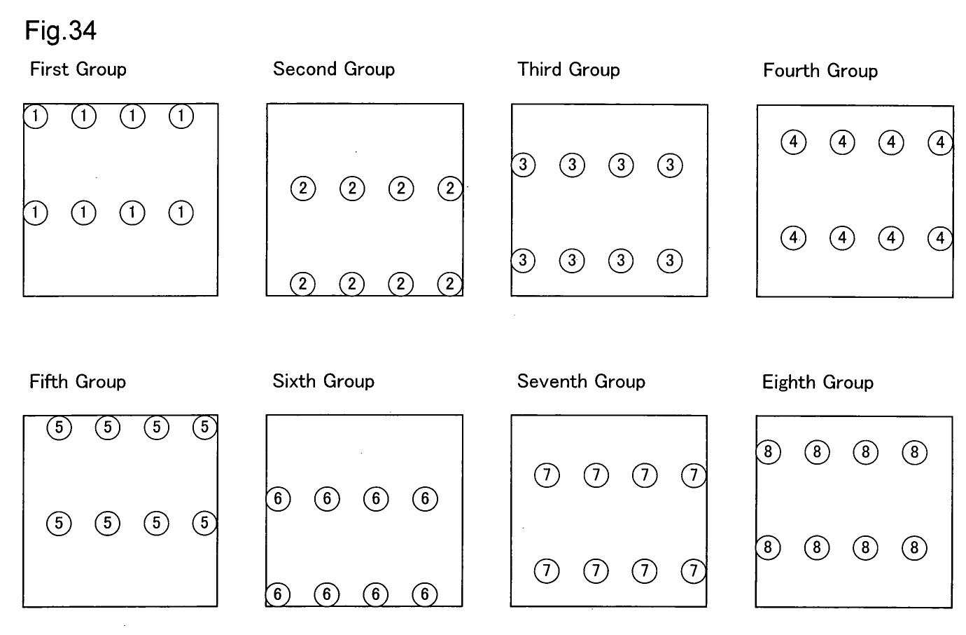

FIG. 34 is an explanatory drawing showing the eight pixel position groups divided according to the number of remainders when the pass number is divided by 8. With FIG. 34, each square shape indicates an image area constituted by pixels for which the pixel position number is 1 to 4 of the raster lines for which the raster number is 1 to 4. This image area correlates to the “shared printing area” in the patent claims, and is constituted by combining the print pixels belonging to each of the eight pixel position groups.

In this kind of case as well, the same phenomenon occurs as when there is mutual displacement of the dot positions formed with each pass, so it is possible to attempt to improve the image quality by performing the same process as the embodiments described above so that the dots formed by each of the eight pixel position groups has specified characteristics.

### F-4. Fourth Variation Example

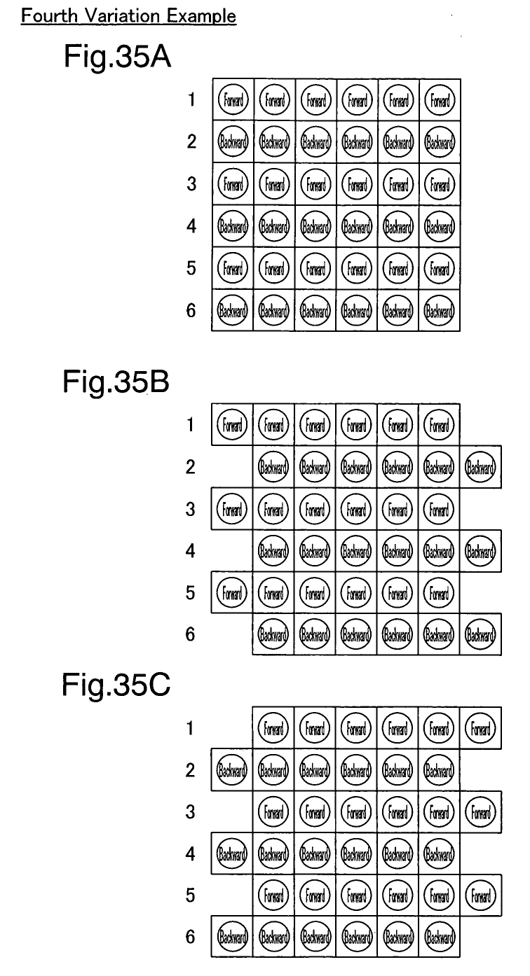

FIGS. 35A, 35B, and 35C are explanatory drawings showing an example of the actual printing state for the bidirectional printing method of the third variation example of the invention. The letters in the circles indicate which of the forward or backward main scans the dots were formed with. FIG. 35A shows the dot pattern when displacement does not occur in the main scan direction. FIG. 35B and FIG. 35C show the dot patterns when displacement does occur in the main scan direction.

With FIG. 35B, in relation to the position of dots formed at the print pixels belonging to the pixel position group for which dots are formed during the forward movement of the printing head, the position of the dots formed at the print pixels belonging to the pixel position group for which dots are formed during the backward scan of the printing head is shifted by 1 dot pitch in the rightward direction. Meanwhile, with FIG. 35C, in relation to the position of the dots formed at the print pixels belonging to the pixel position group for which dots are formed during the forward scan of the printing head, the position of the dots formed at the print pixels belonging to the pixel position group for which dots are formed during the backward scan of the printing head is shifted by 1 dot pitch in the leftward direction.

With the embodiments described above, by giving blue noise or green noise spatial frequency distribution to both the dot patterns of the pixel position group for which dots are formed during the forward scan and the dot patterns of the pixel position group for which dots are formed during the backward scan, image quality degradation due to this kind of displacement is suppressed.

In contrast to this, the third variation example is constituted so that the dot pattern for which the dot pattern formed on the pixel position group formed during the forward scan and the dot pattern formed on the pixel position group formed during the backward scan are shifted by 1 dot pitch in the main scan direction and synthesized has blue noise or green noise spatial frequency distribution, or has a small granularity index.

The constitution of the dither matrix focusing on the granularity index can be constituted so that, for example, the average value of the granularity index when the displacement in the main scan direction is shifted by 1 dot pitch in one direction, when it is shifted by 1 dot pitch in the other direction, and when it is not shifted, is a minimum. Alternatively, it is also possible to constitute this such that the spatial frequency distributions in these cases have a mutually high correlation coefficient.

Note that this variation example is able to increase the robustness level of the image quality in relation to displacement of the dot formation position during forward scan and backward scan, so it is possible to suppress the degradation of image quality not only in cases when the dot formation positions are shifted as a mass during the forward scan and the backward scan, but also when unspecified displacement occurs with part of the pixel position group for which dots are formed during the forward scan and the pixel position group for which dots are formed during the backward scan. For example, it is possible to suppress degradation of the image quality also in cases such as when there is partial variation in the gap of the printing head and the printing paper between the forward scan and the backward scan due to cyclical deformation due to the main scan of the main scan mechanism of the printing head, for example.

F-5. This invention can also be applied to printing that performs printing using a plurality of printing heads. In specific terms, it is also possible to constitute this so that the spatial frequency distributions of dots formed in a plurality of pixel position groups in charge of dot formation by each of the plurality of printing heads have a mutually high correlation coefficient.

By working in this way, for printing using the plurality of printing heads, it is possible to constitute halftone processing with a high robustness level to displacement of dot formation positions between mutual printing heads, for example.

F-6. With this invention, the inventors found not only robustness in relation to dot formation position misalignment, but also suppression of degradation of image quality due to the dot formation time sequence (or dot formation timing displacement).

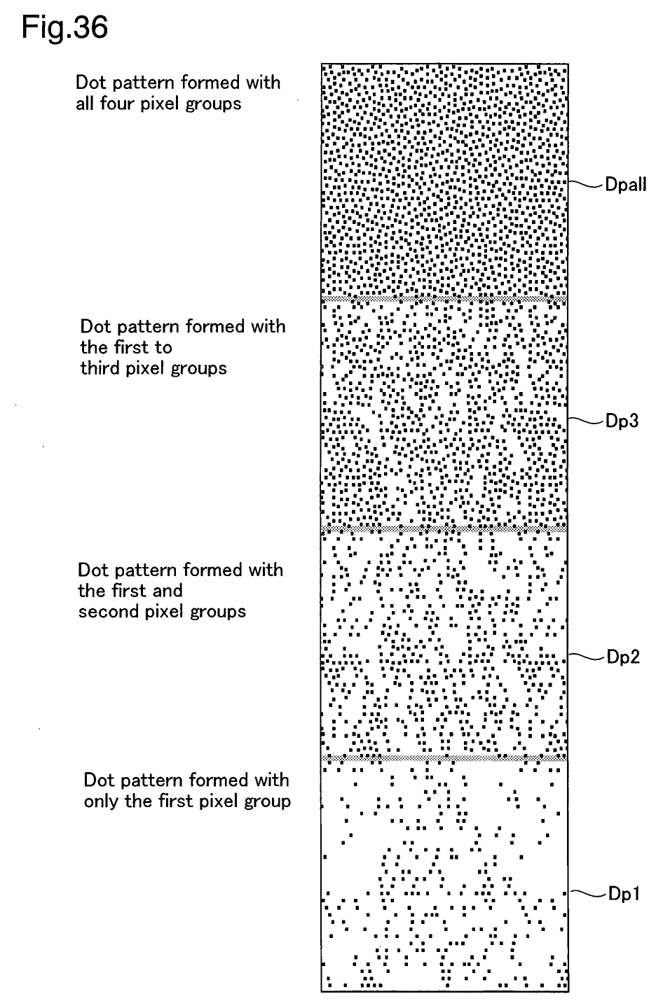

FIG. 36 is an explanatory drawing showing the state of print images being formed by mutually combining in a shared printing area four image groups in a case when conventional halftone processing is performed. FIG. 36 shows the dot patterns when the four to one pixel position groups are respectively combined.

With conventional halftone processing, processing is performed with a focus on the print image dot dispersion properties formed by all the pixel position groups, so as can be seen from FIG. 23, there is unevenness in the dot dispersion properties of each pixel position group. Specifically, a dense dot state occurs in the low frequency area. This kind of dense dot state causes a state of accumulation of ink drops, excessive sheen, and a bronzing phenomenon at the positions where the dot density is high, and causes image differences with positions at which dot density is low. This image difference causes the problem of it being easy for the human visual sense to recognize this as image unevenness.

This invention suppresses excessive high density of dots and reduces the states of accumulation of ink drops, excessive sheen, and the bronzing phenomenon, and causes uniformity for the overall print image, so it is able to suppress image unevenness. In this way, this invention is able to be applied broadly to printing that forms print images by mutually combining in a common print area print pixels belonging to each of a plurality of pixel position groups, and even if mutual displacement of dots formed in the plurality of pixel position groups is not assumed, it can be applied also in cases when there is a difference in timing of formation of dots formed in the plurality of pixel position groups. This invention generally can be applied in cases when, for dot formation, print pixels belonging to each of the plurality of pixel position groups for which a physical difference is assumed such as displacement of time or formation position are mutually combined in a common print area to form a print image.

F-7. With the embodiments described above, halftone processing was performed using a dither matrix, but it is also possible to use this invention in cases when halftone processing is performed using error diffusion, for example. Using error diffusion can be realized by having error diffusion processing performed for each of a plurality of pixel position groups, for example.

Specifically, another error diffusion processing may be performed for each of the plurality of pixel position groups in addition to the normal error diffusion, or alternatively, more weights may be assigned to errors diffused to the pixels belonging to the plurality of pixel position groups. This is because even with such configurations, inherent characteristics of error diffusion method allows each dot pattern formed on print pixels belonging to each of the plurality of pixel position groups to have specified characteristics for each of the tone values.

Note that with the dither method of the embodiments noted above, by comparing for each pixel the threshold values set in the dither matrix and the tone values of the image data, the presence or absence of dot formation is decided for each pixel, but it is also possible to decide the presence or absence of dot formation by comparing the threshold values and the sum of the tone values with a fixed value, for example. Furthermore, it is also possible to decide the presence or absence of dot formation according to the data generated in advance based on threshold value and on the tone values without directly using the threshold values. The dither method of this invention generally can be a method that decides the presence or absence of dot formation according to the tone value of each pixel and the threshold value set for the pixel position corresponding to the dither matrix.

Finally, the present application claims the priority based on Japanese Patent Application No. 2006-215950 filed on Aug. 8, 2006, which are herein incorporated by reference.

What is claimed is:

1. A printing method of printing on a print medium with a print unit having a printing head, the method comprising:
generating dot data representing a status of dot formation on each print pixel of a print image to be formed on the print medium, by performing halftone process on image data representing a tone value of each pixel making up an original image to determine the status of dot formation; and
printing a print image by forming dots on each print pixel of the print medium according to the dot data during both forward scan and backward scan of the printing head while performing main scan of the printing head, wherein
the printing includes:
forming the print image by mutually combining dots formed on a first pixel group and dots formed on a second pixel group in a common print area, the first pixel group being composed of a plurality of print pixels for which dots are formed during the forward scan of the printing head, the second pixel group being composed of a plurality of print pixels for which dots are formed during the backward scan of the printing head; and
adjusting the print unit to reduce mutual misalignment of dot formation position in the main scanning direction between dots formed during the forward scan and dots formed during the backward scan for a specific dot making up specific binary image represented only by maximum and minimum values of the tone values, wherein
the generating includes setting a condition of the halftone process to reduce potential deterioration of picture quality due to a positional misalignment between the dots formed on the first pixel position group and the dots formed on the second pixel position group.

2. The method according to claim 1, wherein
the printing includes forming a plurality of sizes of dots with different sizes, wherein
the specific dot comprises dots with the largest size among the plurality of sizes of dots.

3. The method according to claim 1, wherein
the printing includes forming black dots formed by black ink, cyan dots formed by cyan ink, magenta dots formed by magenta ink, and yellow dots formed by yellow ink, wherein
the specific dot includes the black dots in case where black-and-white printing is performed.

4. The method according to claim 1, wherein
the printing includes forming black dots formed by black ink, cyan dots formed by cyan ink, magenta dots formed by magenta ink, and yellow dots formed by yellow ink, wherein
the specific dots includes the black dots, the cyan dots, and the magenta dots in case where color printing is performed.

5. The method according to claim 1, wherein
the printing includes forming a plurality of densities of dots with different densities, wherein
the specific dot includes dots with the highest density among the plurality of densities of dots.

6. The method according to claim 1, wherein
both the dots formed on the first pixel group and the dots formed on the second pixel group have either one of blue noise characteristics and green noise characteristics, respectively.

7. The method according to claim 1, wherein
both the dots formed on the first pixel group and the dots formed on the second pixel group have frequency characteristics that an average value of components within a specified low frequency range is smaller than an average value of components within another frequency range at least in the main scan direction on the print medium, wherein
the specified low frequency range is a spatial frequency domain within which visual sensitivity of human is at highest level and ranges from 0.5 cycles per millimeter to 2 cycles per millimeter with a central frequency of 1 cycle per millimeter, wherein
the another frequency range is a domain within which visual sensitivity of human is reduced to almost zero and ranges from 5 cycles per millimeter to 20 cycles per millimeter with a central frequency of 10 cycles per millimeter.

8. A printing apparatus that performs printing on a print medium, the printing apparatus comprising:
a dot data generator that generates dot data representing a status of dot formation on each print pixel of a print image to be formed on the print medium, by performing halftone process on image data representing a tone value of each pixel making up an original image to determine the status of dot formation; and
a print unit that prints a print image by forming dots on each print pixel of the print medium according to the dot data during both forward scan and backward scan of the printing head while performing main scan of the printing head, wherein
the print unit mutually combining dots formed on a first pixel group and dots formed on a second pixel group in a common print area, the first pixel group being composed of a plurality of print pixels for which dots are formed during the forward scan of the printing head, the second pixel group being composed of a plurality of print pixels for which dots are formed during the backward scan of the printing head, wherein
the print is adjusted to reduce mutual misalignment of dot formation position in the main scanning direction between dots formed during the forward scan and dots formed during the backward scan for a specific dot making up specific binary image represented only by maximum and minimum values of the tone values, wherein
the dot data generator is configured such that a condition of the halftone process is set to reduce potential deterioration of picture quality due to a positional misalignment between the dots formed on the first pixel position group and the dots formed on the second pixel position group.
